(19) United States
(12) Patent Application Publication
(10) Pub. No.: US 2026/0367367 A1
(43) Pub. Date: Nov. 19, 2026

(54) OPTICAL SYSTEM AND CAMERA MODULE

(71) Applicant: LG INNOTEK CO., LTD., Seoul (KR)

(72) Inventor: Doo Shik SIN, Seoul (KR)

(73) Assignee: LG INNOTEK CO., LTD., Seoul (KR)

(21) Appl. No.: 19/148,195

(22) PCT Filed: Jan. 17, 2024
(86) PCT No.: PCT/KR2024/000862

§ 371 Date: Jul. 15, 2025

(30) Foreign Application Priority Data
Jan. 17, 2023 (KR) 10-2023-0006842

(51) Int. Cl. G02B 15/14; G02B 7/28; G02B 13/00; G03B 13/36; H04N 23/55

(52) U.S. Cl. CPC G02B 15/143503; G02B 7/282; G02B 13/0045; G02B 13/009; G03B 13/36; H04N 23/55

(57) ABSTRACT

An optical system disclosed in an embodiment of the invention comprises a first to third lens groups, each including at least one lens and arranged along an optical axis from an object side toward a sensor side, wherein: the first and third lens groups have negative power, the second lens group has positive power, a position of the first lens group is fixed, each of the second and third lens groups is movable along the optical axis in accordance with an operation mode, a first lens in the first lens group, which is closest to the object, has positive power and a convex surface on a sensor side, a distance along the optical axis of the first lens group is defined as DG1, a distance along the optical axis of the second lens group is defined as DG2, and the following Equation: 0.5<DG1/DG2<2 is satisfied.

### TECHNICAL FIELD

The embodiment relates to an optical system for improved optical performance and a camera module including the same.

### BACKGROUND ART

The camera module performs the function of photographing an object and saving it as an image or video, and is mounted on various applications. In particular, the camera module is manufactured in an ultra-small size and is applied to portable devices such as smartphones, tablet PCs, and laptops, as well as drones and vehicles, providing various functions. For example, the optical system of the camera module may include an imaging lens that forms an image, and an image sensor that converts the formed image into an electrical signal. At this time, the camera module may perform an autofocus AF function that automatically adjusts the distance between the image sensor and the imaging lens to align the focal length of the lens, and may perform a zooming function of zooming up or zooming out by increasing or decreasing the magnification of a distant object through a zoom lens. In addition, the camera module adopts image stabilization (IS) technology to compensate for or prevent image shake caused by camera movement due to unstable fixation devices or user movement.

The most important element for the camera module to obtain an image is the imaging lens that forms the image. Recently, interest in high resolution has been increasing, and research is being conducted on an optical system including multiple lenses to implement this. For example, research is being conducted using multiple imaging lenses with positive (+) or negative (−) refractive power to implement high resolution. However, there is a problem that it is difficult to derive excellent optical characteristics and aberration characteristics when multiple lenses are included. In addition, when multiple lenses are included, the overall length, height, etc. may increase due to the thickness, distance, size, etc. of the multiple lenses, and this increases the overall size of the module including the multiple lenses.

The size of the image sensor is increasing to implement high-resolution and high-quality images. However, when the size of the image sensor increases, the TTL (Total track length) of the optical system including multiple lenses also increases, which causes a problem in that the thickness of the camera, mobile terminal, etc. including the optical system also increases.

When the optical system includes multiple lenses, the position of at least one lens or a lens group including at least one lens can be controlled to perform functions such as zoom and autofocus AF. However, when the lens or the lens group performs the function, the amount of movement of the lens or the lens group can increase exponentially. Accordingly, the optical system may require a lot of energy for the movement of the lens or the lens group, and there is a problem in that a large volume is required considering the amount of movement. In addition, there is a problem in that the aberration characteristics are deteriorated due to the movement of the lens or the lens group. Accordingly, there is a problem in that the optical characteristics are deteriorated at a certain magnification when the zoom and autofocus AF functions are performed. Therefore, a new optical system that can solve the above-described problems is required.

### DETAILED DESCRIPTION OF THE INVENTION

### Technical Problem

The embodiment provides an optical system with improved optical characteristics. The embodiment provides an optical system and a camera module capable of photographing at various magnifications. The embodiment provides an optical system and a camera module having improved aberration characteristics at various magnifications. The embodiment provides an optical system and a camera module that can be implemented in a small and compact manner.

### Technical Solution

According to an embodiment of the invention, an optical system may include: a first to third lens groups, each including at least one lens and arranged along an optical axis from an object side toward a sensor side, wherein the first and third lens groups have negative power, the second lens group has positive power, a position of the first lens group is fixed, each of the second and third lens groups is movable along the optical axis in accordance with an operation mode, a first lens in the first lens group, which is closest to the object, has positive power and a convex surface on a sensor side, a distance along the optical axis of the first lens group is defined as DG1, a distance along the optical axis of the second lens group is defined as DG2, and the following Equation: 0.5<DG1/DG2<2 is satisfied.

According to an embodiment of the invention, wherein lenses in the first to third lens groups may be made of plastic, and the number of lenses having negative power is greater than the number of lenses having positive power in the first to third lens groups.

According to an embodiment of the invention, the distance along the optical axis of the second lens group may be greater than distances along the optical axis of each of the first and third lens groups. A lens having the largest absolute focal length among lenses in the first to third lens groups may be disposed in the first lens group. A distance along the optical axis of the third lens group is defined as DG3, a distance along the optical axis from an object-side surface of the lens in the first lens group closest to the object to a top surface of the image sensor is defined as TTL, and the following Equation: 2<TTL/(DG2+DG3)<5 is satisfied.

According to an embodiment of the invention, a distance along the optical axis between a lens closest to the image sensor in the third lens group and the image sensor may be variable in accordance with the operation mode, and the operation mode includes a wide mode, a middle mode, and a tele mode.

According to an embodiment of the invention, a distance along the optical axis between an object-side surface of the lens closest to the object in the first lens group and a sensor-side surface of the lens closest to the image sensor in the third lens group may be variable in accordance with the operation mode, and a distance between the first and second lens groups and a distance between the second and third lens groups are equal to or greater than 0.2 mm and equal to or less than 8 mm.

According to an embodiment of the invention, the wide mode may be defined as Md1, a distance between the first and second lens groups in the wide mode may be DG12, a distance between the second and third lens groups may be DG23, and the following Equation: 1<Md1×(DG12/DG23)<3 may be satisfied. The tele mode may be defined as Md3, a distance between the first and second lens groups in the tele mode may be DG12, a distance between the second and third lens groups may be DG23, and the following Equation: 0<Md3×(DG12/DG23)<0.5 may be satisfied.

According to an embodiment of the invention, a maximum distance between adjacent lenses in accordance with the operation mode may be defined as Md_CG_Max, a minimum distance between adjacent lenses in accordance with the operation mode may be defined as Md_CG_Min, and the following Equation: 4<Md_CG_Max/Md_CG_Min<7 may be satisfied.

According to an embodiment of the invention, the number of lenses in the first lens group may be greater than the number of lenses in the second lens group, and an absolute value of the focal length of the first lens group may be more than twice that of the second lens group. An effective focal length in the wide mode may be defined as FMd1, a focal length of the first lens may be defined as F1, and the following Equation: 2<|F1/FMd1|<7 may be satisfied.

According to an embodiment of the invention, wherein an effective focal length in the tele mode may be defined as FMd3, and the following Equation: 0<|F1/FMd3|<1 may be satisfied. A field of view in the wide mode may be defined as FOV1, a field of view in the middle mode may be defined as FOV2, a field of view in the tele mode may be defined as FOV3, and the following Equation: 8°<FOV3<FOV2<FOV1<45° may be satisfied.

An optical system according to an embodiment of the invention may comprise: a first lens group including first to third lenses; a second lens group including fourth and fifth lenses; and a third lens group including sixth to eighth lenses, wherein: the first to third lens groups are arranged in order from an object side toward a sensor side along an optical axis, the first lens has positive refractive power, and has convex surfaces on both object side and sensor side, the third lens has negative refractive power, and has a concave object-side surface and a convex sensor-side surface, the fourth lens has positive refractive power and a biconvex shape, the eighth lens has negative refractive power, the second and third lens groups are movable along the optical axis, a distance between the eighth lens and the image sensor is variable in accordance with an operation mode, the number of lenses having a refractive index greater than 1.60 among the first to eighth lenses is greater than the number of lenses having a refractive index less than 1.60, a refractive index of the first lens is defined as Nd1, and the following Equation: 1.65<Nd1 is satisfied.

According to an embodiment of the invention, the first and third lens groups may have negative refractive power, and the second and fourth lenses have refractive powers of opposite signs. The fourth lens and the eighth lens each may have a refractive index less than 1.6. The surface of the third lens on the object side may have the largest absolute radius of curvature among the object-side and sensor-side surfaces of the first to eighth lenses.

According to an embodiment of the invention, an effective diameter of the first lens may be the largest among the first to eighth lenses, a maximum length of the first lens in a first direction perpendicular to the optical axis may be different from that in a second direction, a maximum effective size of the largest lens surface among the first to eighth lenses may be defined as CA_Max, and half of a diagonal length of the image sensor may be defined as ImgH, the following Equation: 1<CA_Max/ImgH<3 may be satisfied.

A camera module according to an embodiment of the invention may include: an image sensor; an optical system; and a driving member configured to move at least one of a plurality of lens groups in the optical system along an optical axis, the optical system comprises the optical system disclosed above, the driving member is configured to move positions of each of the second and third lens groups in the optical axis.

### Effects of the Invention

The optical system and the camera module according to the embodiment have various magnifications and can have excellent optical characteristics when providing various magnifications. In detail, the embodiment can have various magnifications by controlling the movement distance of each of the moving lens groups and can provide an autofocus AF function for a subject. The optical system and the camera module according to the embodiment can correct the aberration characteristics of the plurality of lens groups or mutually complement the aberration characteristics that change due to movement. Accordingly, the optical system according to the embodiment can minimize or prevent the chromatic aberration change and the aberration characteristic change that occur when the magnification changes.

The optical system and the camera module according to the embodiment can control the effective focal length EFL by moving only some of the plurality of lens groups and can minimize the movement distance of the moving lens group. Accordingly, the optical system can reduce the moving distance of the moving lens group according to the change in the operation mode, and can minimize the power consumption required when the lens group is moved. The optical system may have at least one lens included in the fixed group and the moving group has a non-circular shape. Accordingly, the optical system can reduce the height of the optical system while maintaining the optical performance, and can secure a space in which the lens group arranged between the plurality of lens groups is structurally arranged.

The optical system and the camera module according to the embodiment can adjust the magnification by moving a lens group other than the first lens group adjacent to the subject among the plurality of lens groups. Accordingly, the optical system can have a constant TTL value even when the lens group is moved according to the change in magnification. Therefore, the optical system and the camera module including the same can be provided with a slimmer structure.

### BRIEF DESCRIPTION OF THE DRAWINGS

FIG. 1 is a configuration diagram of an optical system and a camera module having the same according to an embodiment of the invention.

FIG. 2 is an example of a change in the first mode of the optical system of FIG. 1.

FIG. 3 is an example of a change in the third mode in the optical system of FIGS. 1 and 2.

FIG. 4 is a configuration having a reflective mirror in the optical system of FIG. 1.

FIG. 5 is a table of lens data of an optical system according to an embodiment of the invention.

FIG. 6 is a table illustrating aspherical coefficients of lenses of an optical system according to an embodiment of the invention.

FIG. 7 is a graph illustrating relative illumination according to positions of wide, middle, and tele modes according to an embodiment of the invention.

FIG. 8 is a graph of diffraction MTF in an optical system of the first mode (Wide Mode) according to an embodiment of the invention.

FIG. 9 is a graph of diffraction MTF in an optical system of the second mode (Middle Mode) according to an embodiment of the invention.

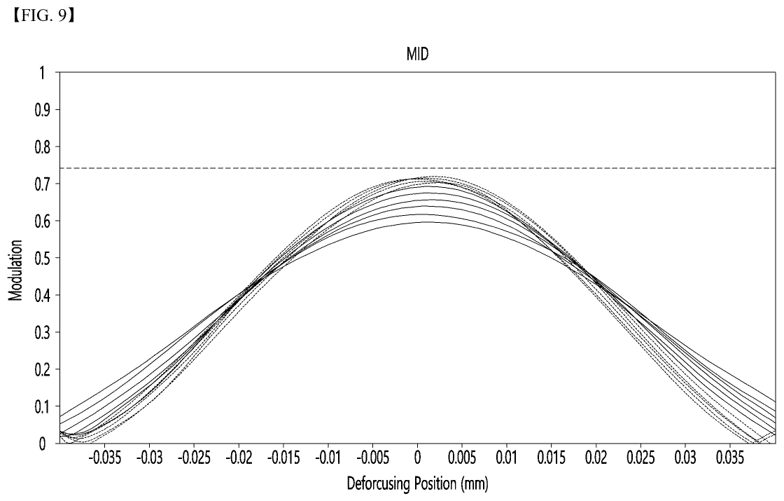

FIG. 10 is a graph of diffraction MTF in an optical system of the third mode (Tele Mode) according to an embodiment of the invention.

FIG. 11 is a graph illustrating aberration characteristics in an optical system of the first mode according to an embodiment of the invention.

FIG. 12 is a graph illustrating aberration characteristics in an optical system of the second mode according to an embodiment of the invention.

FIG. 13 is a graph illustrating aberration characteristics in an optical system of the third mode according to an embodiment of the invention.

FIG. 14 is a drawing illustrating a camera module according to an embodiment of the invention applied to a mobile terminal.

### BEST MODE

Hereinafter, preferred embodiments of the present invention will be described in detail with reference to the attached drawings. However, the technical idea of the present invention is not limited to some of the embodiments described, but can be implemented in various different forms, and within the scope of the technical idea of the present invention, one or more of the components between the embodiments can be selectively combined or substituted and used. In addition, terms (including technical and scientific terms) used in the embodiments of the present invention can be interpreted as meanings that can be generally understood by those with ordinary knowledge in the technical field to which the present invention belongs, unless explicitly specifically defined and described, and terms that are commonly used, such as terms defined in a dictionary, can be interpreted in consideration of the contextual meaning of the related technology. The terms used in the embodiments of the present invention are for describing the embodiments and are not intended to limit the present invention.

In this specification, the singular may also include the plural unless specifically stated in the phrase, and when it is described as “at least one (or more than one) of A and (and) B, C,” it may include one or more of all combinations that can be combined with A, B, and C. In addition, when describing the components of the embodiments of the present invention, terms such as first, second, A, B, (a), (b), etc. may be used. These terms are only intended to distinguish the components from other components, and are not limited by the nature, order, or sequence of the components. In addition, when a component is described as being ‘connected’, ‘coupled’, or ‘connected’ to another component, the component may include not only the case where it is directly connected, coupled, or connected to the other component, but also the case where it is ‘connected’, ‘coupled’, or ‘connected’ by another component between the component and the other component. When it is described in the specification that each component is formed or arranged “above or below”, the above or below includes not only the case where two components are in direct contact with each other, but also the case where one or more other components are formed or arranged between the two components. In addition, when expressed as “above or below”, it may include the meaning of not only the upward direction but also the downward direction based on one component.

In the specification, the convexity of the lens surface may mean that the lens surface in the area corresponding to the optical axis has a convex shape based on the optical axis, and the concaveness of the lens surface may mean that the lens surface in the area corresponding to the optical axis has a concave shape. In addition, the “object-side surface” may mean the surface of the lens facing the object side based on the optical axis, and the “sensor-side surface” may mean the surface of the lens facing the imaging surface (image sensor) based on the optical axis. In addition, the center thickness of the lens may mean the thickness of the lens in the optical axis direction. In addition, the vertical direction may mean the direction perpendicular to the optical axis, and the end of the lens or lens surface may mean the end of the effective area of the lens through which the incident light passes. In addition, the size of the effective diameter of the lens surface may have a measurement error of up to ±0.4 mm depending on the measurement method, etc.

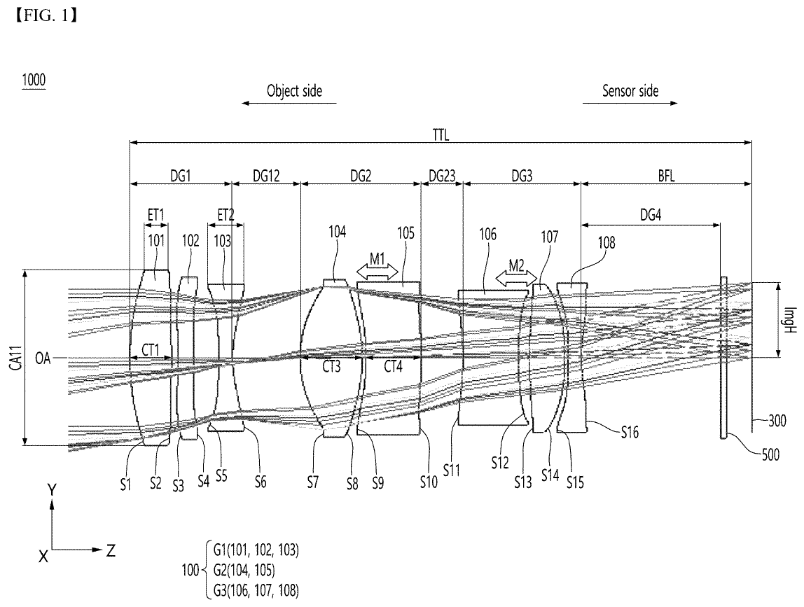

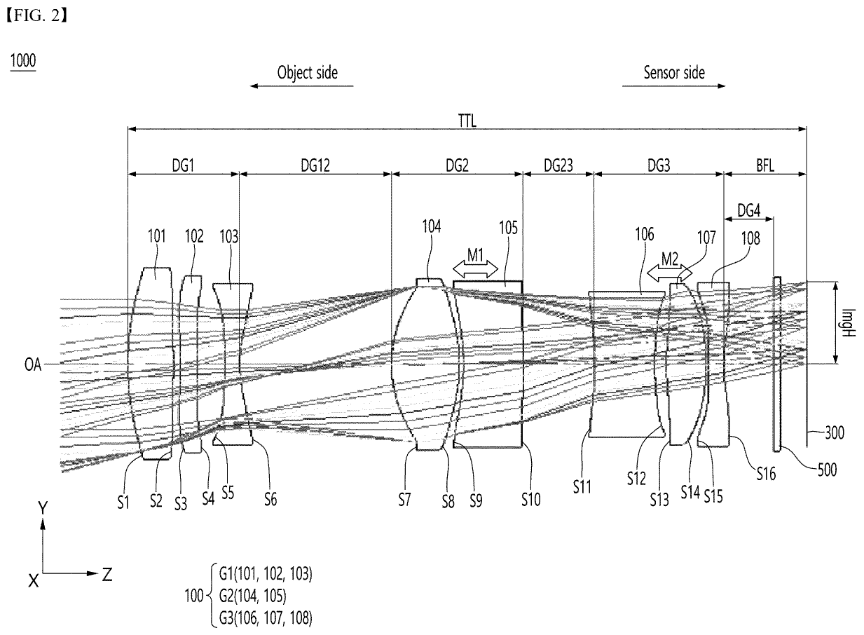

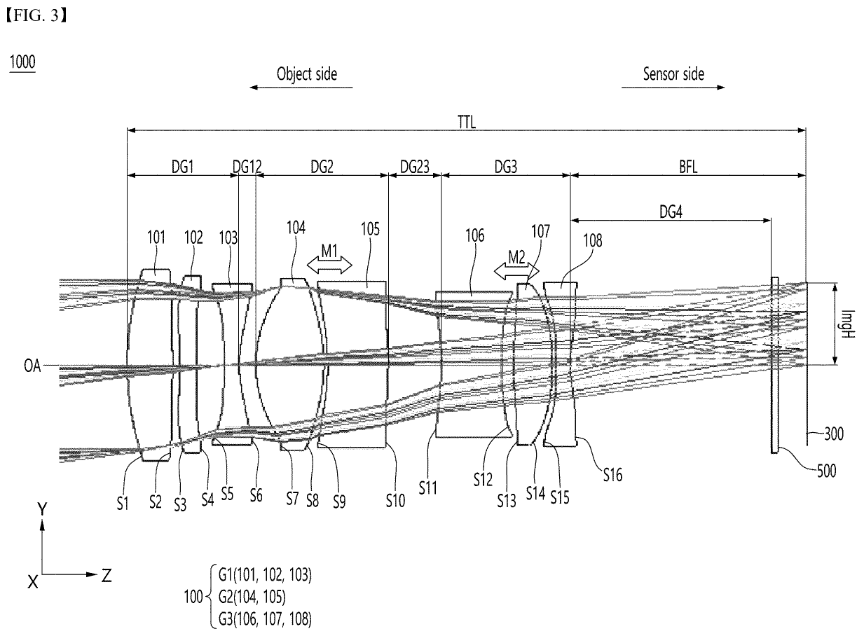

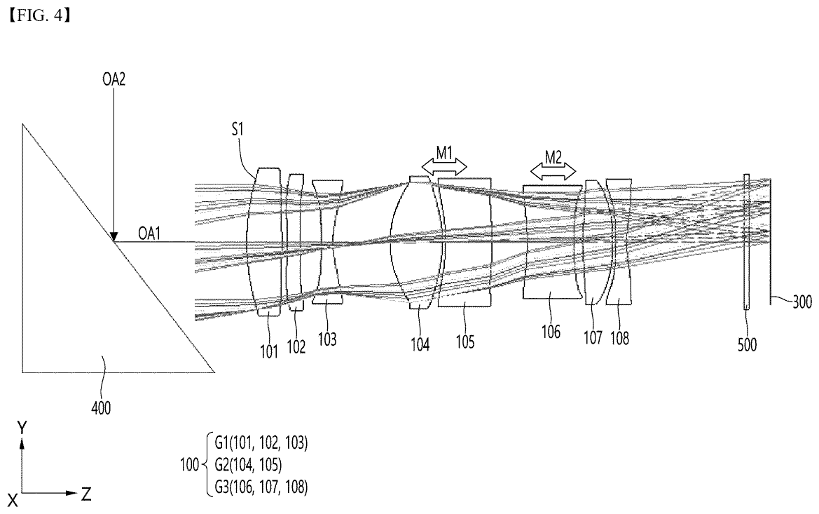

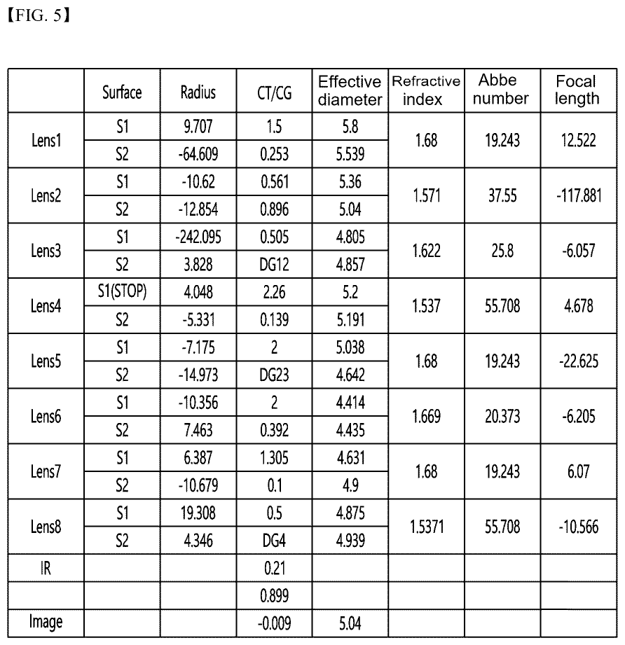

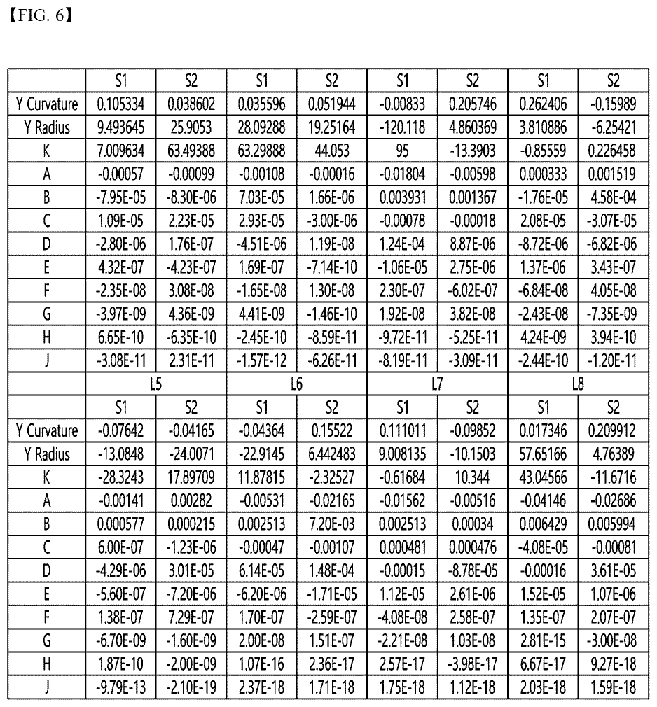

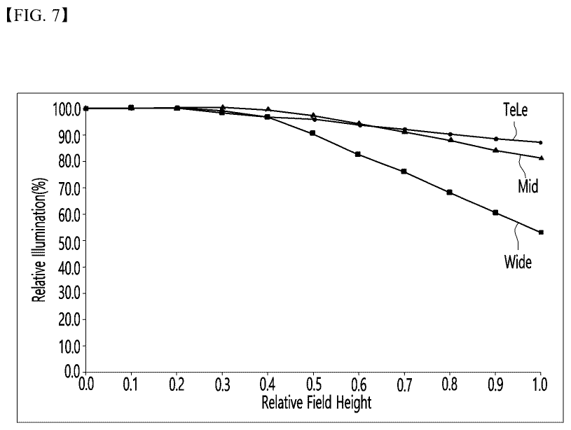

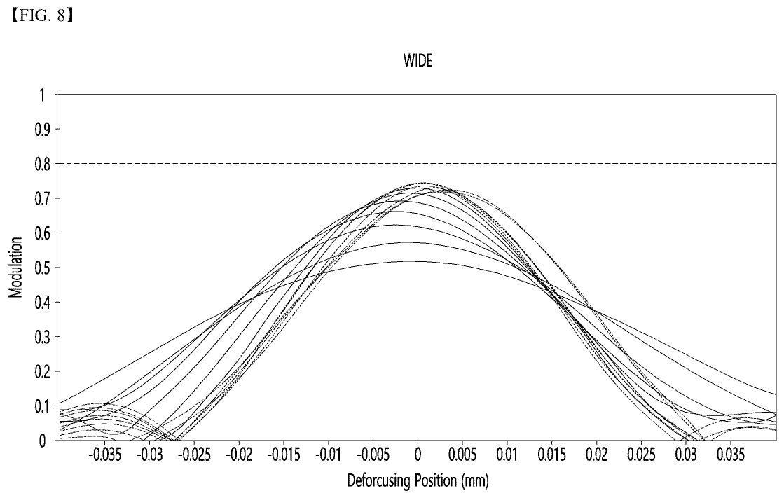

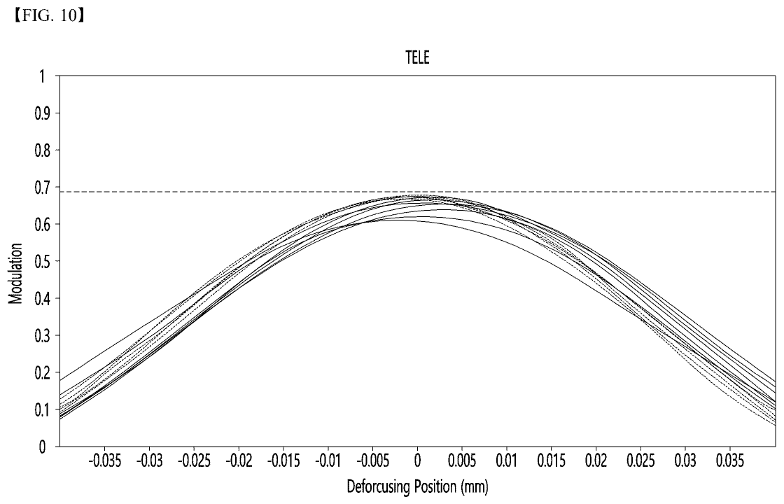

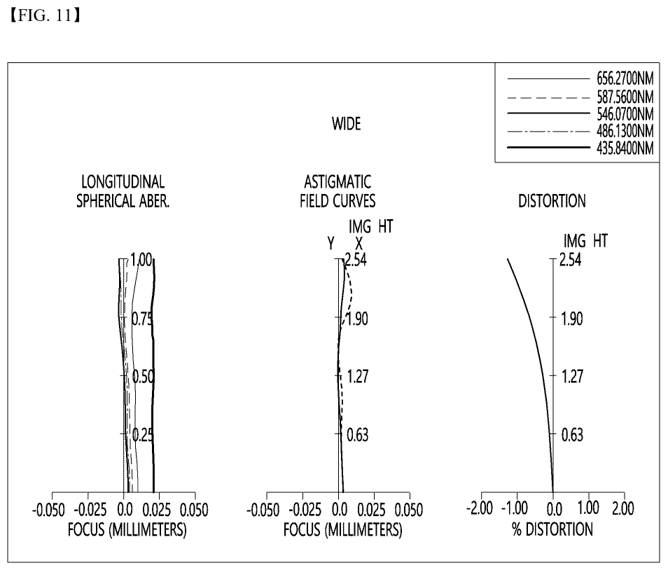

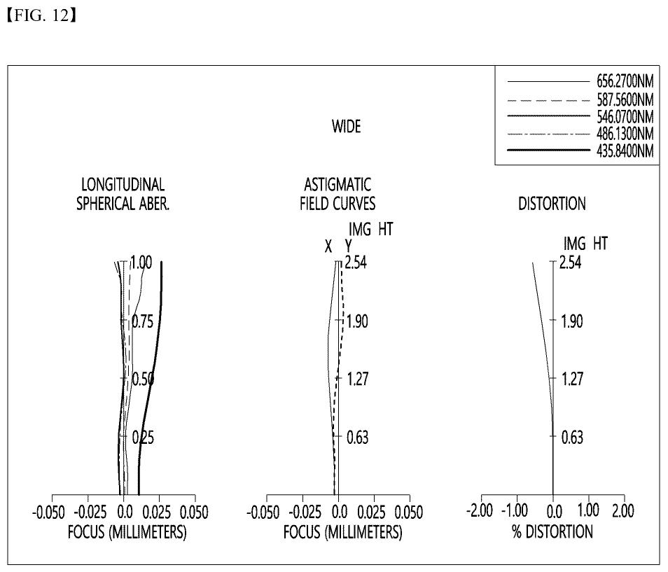

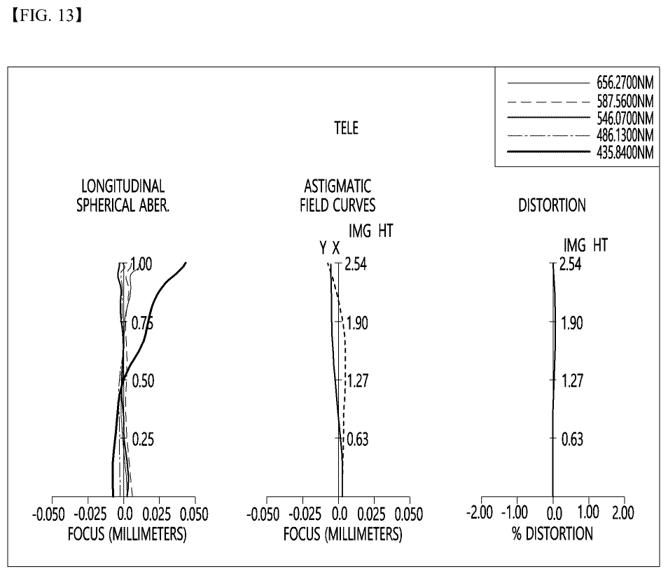

FIG. 1 is a configuration diagram of a first mode of a camera module or optical system according to an embodiment of the invention, FIG. 2 is an example of a change from the first mode of the optical system of FIG. 1 to the second mode, FIG. 3 is an example of a change from the optical system of FIGS. 1 and 2 to the third mode, FIG. 4 is a configuration having a reflective mirror in the optical system of FIG. 1, FIG. 5 is a table of lens data of an optical system according to an embodiment of the invention, FIG. 6 is a table illustrating aspherical coefficients of lenses of an optical system according to an embodiment of the invention, FIG. 7 is a graph illustrating relative illuminance according to positions of Wide, Middle, and Tele modes in a camera module according to an embodiment of the invention, FIG. 8 is a graph of diffraction MTF in an optical system of a first mode (Wide Mode) according to an embodiment of the invention, FIG. 8 is a graph of diffraction MTF in an optical system of a second mode (Middle mode) according to an embodiment of the invention, and FIG. 10 is a graph illustrating an embodiment of the invention. A graph of diffraction MTF in an optical system of the third mode (Tele mode) according to an example, FIG. 11 is a graph illustrating aberration characteristics in an optical system of the first mode according to an embodiment of the invention, FIG. 12 is a graph illustrating aberration characteristics in an optical system of the second mode according to an embodiment of the invention, and FIG. 13 is a graph illustrating aberration characteristics in an optical system of the third mode according to an embodiment of the invention.

Referring to FIGS. 1 to 6, an optical system 1000 according to an embodiment may include a plurality of lens groups G1, G2, and G3. In detail, the plurality of lens groups G1, G2, and G3 may have at least two lens groups that can move in the direction of the optical axis OA and at least one lens group that is fixed in position. The plurality of lens groups G1, G2, and G3 may include a lens group fixed on the object side and a plurality of movable lens groups that can move on the sensor side. The plurality of movable lens groups may include an object-side lens group and a sensor-side lens group.

The lens group fixed on the object side may be defined as the first lens group G1, the object-side moving lens group may be defined as the second lens group G2, and the sensor-side moving lens group may be defined as the third lens group G3. The second lens group G2 may be arranged between the first lens group G1 and the third lens group G3. The first lens group G1 refracts incident light toward the second lens group G2, the second lens group G2 moves along the optical axis OA and changes the zoom magnification (focal length), and the third lens group G3 moves along the optical axis OA and can adjust the focus position on the image surface of the image sensor 300.

The optical system 1000 may include a first lens group G1, a second lens group G2, and a third lens group G3 sequentially arranged along the optical axis OA from the object toward the sensor. The optical system 1000 may include an image sensor 300 on the sensor side of the third lens group G3. The first lens group G1 may include a lens closest to the object side, and the third lens group G3 may include a lens closest to the sensor side. Each of the first to third lens groups G1, G2, and G3 may have positive (+) or negative (−) refractive power. For example, a lens group having positive refractive power may be smaller than a lens group having negative refractive power.

The first lens group G1 may have a refractive power of a sign opposite to the refractive power of the second lens group G2. For example, the first lens group G1 may have negative (−) refractive power, and the second lens group G2 may have positive (+) refractive power. The second lens group G2 may have a refractive power of a sign opposite to the sign of the refractive power of the third lens group G3. For example, the second lens group G2 may have positive (+) refractive power, and the third lens group G3 may have negative (−) refractive power.

The absolute value of the focal length of the first lens group G1 may be greater than the absolute value of the focal lengths of the second and third lens groups G2, G3. For example, the absolute value of the focal length of the first lens group G1 may be more than twice the focal length of the second lens group G2. Accordingly, the first lens group G1 may disperse the incident light. The focal length of the second lens group G2 may be smaller than the absolute value of the focal length of the third lens group G3. The absolute value of the focal length of the third lens group G3 may be smaller than the absolute value of the focal length of the first lens group G1. The power of the first and third lens groups G1, G3 may have negative power, and the power of the second lens G2 may have positive power. The power is the reciprocal of the focal length value.

The number of lenses of the first lens group G1 may be larger than the number of lenses of the second lens group G2. The number of lenses of the second lens group G2 may be equal to or smaller than the number of lenses of the third lens group G3. The number of lenses of the first lens group G1 may include at least three lenses for adjusting the incident light amount, refractive power, and chromatic aberration. The third lens group G3 may include at least two or three lenses.

The number of lenses in the first to third lens groups G1, G2, and G3 may be two or more. At least one of the first and third lens groups G1, G3 may include three or more lenses. As another example, the optical system may further include at least one lens whose position is fixed between the third lens group G3 and the image sensor 300. Accordingly, the optical system 1000 may include seven or more lenses and ten or fewer lenses.

Since the first and second lens groups G1 and G2 have refractive powers of opposite signs (+,−), aberrations may be corrected, and since the second and third lens groups G2 and G3 have refractive powers of opposite signs (+,−), aberrations may be corrected.

The absolute value of the focal length of each of the first to third lens groups G1, G2, and G3 may decrease in the order of the first lens group G1, the third lens group G3, and the second lens group G2. The first lens group G1 is fixed in position, the second lens group G2 and the third lens group G3 move M1 and M2 in the direction of the optical axis OA, and the optical system 1000 may provide various magnifications by the movement of at least two lens groups. Hereinafter, the first to third lens groups G1, G2, and G3 will be described in more detail. The first lens group G1 may include at least two lenses having refractive powers of opposite signs, and at least two lenses may have refractive powers of the same sign. For example, the first lens group G1 may include three lenses. The first lens group G1 may have a greater number of lenses having negative refractive power than lenses having positive refractive power.

The first lens group G1 may include a plurality of lenses, and the plurality of lenses may have a set interval on the optical axis OA. In detail, the center interval between the plurality of lenses 101, 102, and 103 included in the first lens group G1 may be a fixed interval according to the operation mode described below. For example, the center interval between adjacent lenses 101, 102, and 103 in the first lens group G1 may not change depending on the operation mode and may have a constant interval. Here, the center interval between the lenses may mean the optical axis interval between the adjacent lenses. The second lens group G2 may include a plurality of lenses, and may include lenses 104 and 105 having refractive powers of opposite signs. The plurality of lenses 104 and 105 included in the second lens group G2 may have a set interval. In detail, the center interval between adjacent lenses 104 and 105 may be a fixed interval according to the operation mode described later.

The third lens group G3 may include a plurality of lenses, and may include two or more lenses having opposite refractive powers. The number of lenses included in the third lens group G3 may be greater than the number of lenses having positive refractive powers. The number of lenses included in the third lens group G3 may be at least one more than the number of lenses included in the second lens group G2. The number of lenses included in the third lens group G3 may be equal to the number of lenses included in the first lens group G1. For example, the third lens group G3 may include three lenses. The plurality of lenses 106, 107, and 108 included in the third lens group G3 may have a set interval. In detail, the center interval between the plurality of lenses 106, 107, and 108 included in the third lens group G3 may be constant without changing even when the operation mode described later changes. For example, the center intervals between adjacent lenses 106, 107, and 108 may be constant without changing depending on the operation mode. The last lens included in the third lens group G3 has a set interval with the image sensor 220 or/and the optical filter 500, and the interval may vary depending on the operation mode.

The optical system 1000 may include first to eighth lenses 101, 102, 103, 104, 105, 106, 107, and 108. The first lens group G1 may include the first to third lenses 101, 102, and 103, and the second lens group G2 may include the fourth and fifth lenses 104 and 105. In addition, the third lens group G3 may include the sixth to eighth lenses 106, 107, and 108. The first to eighth lenses 101-108 and the image sensor 300 may be sequentially arranged along the optical axis OA of the optical system 1000.

At least one lens in the first lens group G1 may have different effective lengths in the first direction (X) orthogonal to the optical axis OA and in the second direction (Y). The lenses in the first lens group G1 having different effective lengths in the first and second directions (X, Y) may be non-circular lenses, and for example, the effective length in the second direction (Y) may be smaller than the effective length in the first direction (X). One or more of the first to third lenses 101, 102, and 103 may have an effective length in the second direction (Y) of the object-side surface smaller than the effective length in the first direction (X). At least one of the lenses in the second lens group G2 may have different effective lengths in the first direction (X) orthogonal to the optical axis OA and in the second direction (Y). The lenses of the second lens group G2 having different effective lengths in the first and second directions (X, Y) may be non-circular lenses, for example, the effective length in the second direction (Y) may be smaller than the effective length in the first direction (X). One or both of the fourth and fifth lenses 104 and 105 may have an effective length in the second direction (Y) of the object-side surface smaller than the effective length in the first direction (X).

At least one of the lenses in the third lens group G3 may have different lengths in the first direction (X) and the second direction (Y) perpendicular to the optical axis OA. The lenses of the first lens group G1 having different effective lengths in the first and second directions (X, Y) may be non-circular lenses, for example, the effective length in the second direction (Y) may be smaller than the effective length in the first direction (X). In detail, among the lenses in the lens unit 100, the first lens 101 having the largest effective length may have an effective length in the first direction (X) that is longer than an effective length in the second direction (Y). The second lens 102 may have an effective length in the first direction (X) that is longer than an effective length in the second direction (Y). The fourth lens 104 may have an effective length in the first direction (X) that is longer than an effective length in the second direction (Y).

The optical system 1000 according to the embodiment may have improved assemblability by non-circular lens(es) and may have a mechanically stable form. In addition, the optical system 1000 may significantly reduce the moving distance DG12, DG23, and DG4 of the moving lens groups G2 and G3 and provide various magnifications. In addition, since the lenses having a large effective length in the second direction (Y) are provided in a shape in which both sides of the second direction (Y) are cut, the height or thickness of the optical system 1000 and the camera module in the second direction (Y) can be reduced. Accordingly, the increase in the thickness of the device having the slim optical system 1000 and the camera module can be suppressed.

Each of the lenses in the lens unit 100 may include an effective area and an ineffective area. The effective area may be an area of an effective diameter and may be an area through which light incident on each of the first to eighth lenses 101-108 passes. The effective area may be an area in which the incident light is refracted to implement optical characteristics. The ineffective area may be arranged around the effective area. The ineffective area may be an area in which the light is not incident. In other words, the ineffective area may be an area unrelated to the optical characteristics. In addition, the non-valid area may be an area fixed to a barrel (not shown) that accommodates the lens.

The image sensor 300 can detect light. The image sensor 300 can detect light that has sequentially passed through the lens unit 100, for example, the first to eighth lenses 101-108. The image sensor 300 may include a CCD (Charge Coupled Device) or a CMOS (Complementary Metal Oxide Semiconductor). The optical system 1000 may further include an optical filter 500. The optical filter 500 may be arranged between the lens unit 100 and the image sensor 300. The optical filter 500 may be arranged between the image sensor 300 and the third lens group G3. For example, the optical filter 500 may be placed between the eighth lens 108 and the image sensor 300. The optical filter 500 may include at least one of an infrared filter and a cover glass. The optical filter 500 may pass light of a set wavelength band and filter light of a different wavelength band. When the optical filter 500 includes an infrared filter, it may block radiant heat emitted from external light from being transmitted to the image sensor 300. The optical filter 500 may transmit visible light and reflect infrared light.

The optical system 1000 may include an aperture stop (not shown). The aperture stop may adjust the amount of light incident on the optical system 1000. The aperture stop may be placed around the object-side surface of the fourth lens 104. The above aperture stop may be arranged between two lenses selected from the first to eighth lenses 101-108. For example, the aperture stop may be arranged on the periphery between the third lens 103 and the fourth lens 104. The aperture stop may be arranged on the periphery of the sensor-side surface of the third lens 103 or the periphery of the object-side surface of the fourth lens 104. Alternatively, at least one lens of the first to eighth lenses 101-108 may function as an aperture stop. For example, an outer portion of the object-side surface or the sensor-side surface of one lens selected from the first to eighth lenses 101-108 may function as an aperture stop for controlling the amount of light. For example, at least one lens surface of the sensor-side surface of the third lens 103 and the object-side surface of the fourth lens 104 may function as an aperture stop.

The object-side surface and the sensor-side surface of the first to eighth lenses 101-108 may be aspherical. The first to eighth lenses 101-108 may be made of a plastic material. Alternatively, at least one of the first to third lenses 101, 102, and 103 may be made of a glass material.

As shown in FIG. 4, the optical system 1000 may further include an optical path changing member 400. The optical path changing member 400 may reflect light incident from the outside and change the path of the light from the second path OA2 to the first path OA1. The optical path changing member 400 may include a reflector or a prism. For example, the optical path changing member 400 may include a right-angled prism. When the optical path changing member 400 includes a right-angle prism, the optical path changing member 400 can reflect the second path OA2 of incident light at an angle of 90 degrees to change the first path OA1 of the light. The first path OA1 may be in the direction of the optical axis of the optical system. The optical path changing member 400 may be arranged closer to the object side than the plurality of lenses. That is, when the optical system 1000 includes the optical path changing member 400, the optical path changing member 300, the first lens 101, the second lens 102, the third lens 103, the fourth lens 104, the fifth lens 105, the sixth lens 106, the seventh lens 107, the eighth lens 108, the filter 500, and the image sensor 300 may be arranged in this order from the object side toward the sensor side. The above-described optical path changing member 400 can change the path of light incident from the outside into a set direction. For example, the optical path changing member 400 can change the second path OA2 of light incident on the optical path changing member 400 in a second direction (Y) into a first path OA1 in a third direction (Z) which is the arrangement direction of the plurality of lenses. When the optical system 1000 includes the optical path changing member 400, the optical system can be applied to a folded camera, thereby reducing the thickness of the camera. In detail, when the optical system 1000 includes the optical path changing member 400, light incident in a direction (Y) perpendicular to a surface of a device to which the optical system 1000 is applied can be changed into a direction (Z) parallel to the surface of the device. Accordingly, the optical system 1000 including a plurality of lenses can have a thinner thickness within the device, so that the height of the device can be reduced.

If the optical system 1000 does not include the optical path changing member, the plurality of lenses may be arranged to extend in a direction (Y) perpendicular to the surface of the device. Accordingly, the optical system 1000 including the plurality of lenses has a high height in a direction (first direction) perpendicular to the surface of the device, and thus it may be difficult to form the optical system 1000 and the device including it thin. However, if the optical system 1000 includes the optical path changing member 400, the plurality of lenses may be arranged to extend in a direction (Z) parallel to the surface of the device. That is, the optical system 1000 is arranged such that the optical axis OA is parallel to the surface of the device and may be applied to a folded camera. Accordingly, the optical system 1000 including the lens unit 100 may have a low height in a direction perpendicular to the surface of the device. Accordingly, the camera including the optical system 1000 can have a thin thickness within the device, and the thickness of the device can also be reduced. As another example, the optical path changing member can be arranged between two lenses of the lens unit 100, or can be further arranged between the last lens adjacent to the image sensor 300 and the image sensor 300. As another example, the optical path changing member can be provided in multiple pieces. In detail, a plurality of the optical path changing members can be arranged between the object and the image sensor 300. For example, the plurality of optical path changing members can include a first optical path changing member arranged closer to the object side than the plurality of lenses, and a second optical path changing member arranged between the last lens and the image sensor 300. Accordingly, the optical system 1000 can have various shapes and heights depending on the camera to which it is applied, and can have improved optical performance.

Referring to FIGS. 1 to 3, the first lens 101 may be arranged closest to the object among the plurality of lenses, and the eighth lens 108 may be arranged closest to the image sensor 300. For convenience of explanation, the center thickness of each of the first to eighth lenses 101 to 108 is CT1 to CT8, the edge thickness is ET1 to ET8, the Abbe number is Vd1 to Vd8, the refractive index is Nd1 to Nd8, the average of the effective lengths is CA1 to CA8, and the focal length may be defined as F1 to F8. The first lens 101 may have positive (+) refractive power at the optical axis OA. The first lens 101 may include a plastic or glass material, and may be, for example, a plastic material. The first lens 101 may include a first surface S1 on the object side and a second surface S2 on the sensor side. The first surface S1 may have a convex shape on the optical axis OA, and the second surface S2 may have a convex shape on the optical axis OA. That is, the first lens 101 may have a convex shape on both sides on the optical axis OA. Alternatively, the first lens 101 may have a convex shape on the optical axis on the first surface S1, and a concave shape on the optical axis OA on the second surface S2. Alternatively, the first lens 101 may have a meniscus shape that is convex on the sensor side. At least one surface of the first surface S1 and the second surface S2 may be aspherical. For example, both the first surface S1 and the second surface S2 may be aspherical. The aspherical coefficients of the first and second surfaces S1, S2 may be represented by LIS1, L1S2 in FIG. 6.

The first lens 101 may have the largest effective length among the lenses, that is, the maximum effective length. That is, the effective length of the first surface S1 of the first lens 101 in the second direction (Y) may be the largest among the lenses. The average of the effective lengths of the first and second surfaces S1, S2 of the first lens 101 in the second direction (Y) may be greater than the average of the effective lengths of the object-side surfaces and the sensor-side surfaces of the second to eighth lenses 102 to 108. Accordingly, the first lens 101 may improve optical aberrations or control incident light. The first surface S1 and the second surface S2 may be provided without a critical point from the optical axis to the end of the effective area.

The second lens 102 may have positive (+) or negative (−) refractive power on the optical axis OA, and may have negative (−) refractive power, for example. The second lens 102 may include a plastic or glass material, and may be made of a plastic material, for example. The second lens 102 may include a third surface S3 defined as an object-side surface and a fourth surface S4 defined as a sensor-side surface. The third surface S3 may have a concave shape on the optical axis OA, and the fourth surface S4 may have a convex shape on the optical axis OA. The second lens 102 may have a convex meniscus shape toward the sensor in the optical axis OA. Alternatively, the third surface S3 may have a convex shape on the optical axis OA, and the fourth surface S4 may have a concave shape on the optical axis OA. Alternatively, the third surface S3 may have a concave shape on the optical axis OA, and the fourth surface S4 may have a concave shape on the optical axis OA. Alternatively, the third surface S3 may have a convex shape on the optical axis OA, and the fourth surface S4 may have a convex shape on the optical axis OA. At least one of the third surface S3 and the fourth surface S4 of the second lens 102 may be aspherical. For example, both the third surface S3 and the fourth surface S4 may be aspherical. The aspherical coefficients of the third and fourth surfaces S3, S4 can be represented by L2S1 and L2S2 in FIG. 6. The third surface S3 and the fourth surface S4 can be provided without a critical point from the optical axis to the end of the effective area, or at least one of the third surface S3 and the fourth surface S4 can have a critical point.

The third lens 103 can have a refractive power of the same sign as the refractive power of the second lens 102 on the optical axis OA. That is, the third lens 103 can have a negative (−) refractive power. The third lens 103 can include a plastic or glass material, and can be, for example, a plastic material. The third lens 103 can include a fifth surface S5 defined as an object-side surface and a sixth surface S6 defined as a sensor-side surface. The fifth surface S5 may have a concave shape on the optical axis OA, and the sixth surface S6 may have a concave shape on the optical axis OA. Alternatively, the fifth surface S5 may have a convex shape on the optical axis OA, and the sixth surface S6 may have a concave shape. Alternatively, the fifth surface S5 may have a concave shape on the optical axis OA, and the sixth surface S6 may have a convex shape. At least one of the fifth surface S5 and the sixth surface S6 of the third lens 103 may be aspherical. For example, both the fifth surface S5 and the sixth surface S6 may be aspherical. The aspherical coefficients of the fifth and sixth surfaces S5, S6 can be represented by L3S1 and L3S2 in FIG. 6. The fifth surface S5 and the sixth surface S6 can be provided without a critical point from the optical axis to the end of the effective area. As another example, at least one of the fifth surface S5 and the sixth surface S6 can have a critical point from the optical axis to the end of the effective area.

The second lens 102 and the third lens 103 can compensate for chromatic aberration occurring in the first lens 101. The refractive index of the first lens 101 can be greater than 1.6. The first lens 101 can be one of the lenses having the highest refractive index. The radius of curvature of the sixth surface S6 of the third lens 103 can be the smallest among the radii of curvature of the object-side surface and the sensor-side surface of each lens 101, 102, and 103 of the first lens group G1. The absolute value of the radius of curvature of the fifth surface S5 of the third lens 103 can be the largest among the radii of curvature of the object-side surface and the sensor-side surface of each lens 101, 102, and 103 of the first lens group G1. Accordingly, since the first lens group G1 controls the dispersion of light provided to the second lens group G2, the lens size of the second lens group G2 can be reduced. The variable size of the center distance DG12 between the first and second lens groups G1 and G2 can be set according to the operating mode by the radius of curvature of the sixth surface S6 of the third lens 103.

The fourth lens 104 can have positive (+) refractive power on the optical axis OA. The fourth lens 104 can include a plastic or glass material, and can be, for example, a plastic material and have a refractive index of less than 1.6. The fourth lens 104 can include a seventh surface S7 defined as an object-side surface and an eighth surface S8 defined as a sensor-side surface. The seventh surface S7 may have a convex shape with respect to the optical axis OA, and the eighth surface S8 may have a convex shape with respect to the optical axis OA. That is, the fourth lens 104 may have a convex shape on both sides with respect to the optical axis OA. Alternatively, the seventh surface S7 may be convex with respect to the optical axis OA, and the eighth surface S8 may be concave with respect to the optical axis OA. That is, the fourth lens 104 may have a convex meniscus shape toward the object with respect to the optical axis OA. At least one of the seventh surface S7 and the eighth surface S8 of the fourth lens 104 may be aspherical. For example, both the seventh surface S7 and the eighth surface S8 may be aspherical. The aspherical coefficients of the seventh and eighth surfaces S7, S8 can be represented by L4S1 and L4S2 in FIG. 6. The seventh surface S7 and the eighth surface S8 can be provided without a critical point from the optical axis to the end of the effective area.

The fifth lens 105 can have positive (+) or negative (−) refractive power on the optical axis OA. The fifth lens 105 can have negative refractive power opposite to the sign of the refractive power of the fourth lens 104 on the optical axis OA. The fifth lens 105 can include a plastic or glass material, and can be, for example, a plastic material. The fifth lens 105 can include a ninth surface S9 defined as an object-side surface and a tenth surface S10 defined as a sensor-side surface. The ninth surface S9 may have a concave shape on the optical axis OA, and the tenth surface S10 may have a convex shape on the optical axis OA. That is, the fifth lens 105 may have a convex meniscus shape toward the sensor in the optical axis OA. At least one surface among the ninth surface S9 and the tenth surface S10 may be aspherical. For example, both the ninth surface S9 and the tenth surface S10 may be aspherical. The aspherical coefficients of the ninth and tenth surfaces S9, S10 may be expressed as L5S1 and L5S2 in FIG. 6. The ninth surface S9 and the tenth surface S10 of the fifth lens 105 may be provided without a critical point from the optical axis to the end of the effective area.

As another example, the ninth surface S9 of the fifth lens 105 may have a convex shape on the optical axis OA, and the tenth surface S10 may have a convex shape on the optical axis OA. That is, the fifth lens 105 may have a convex shape on both sides in the optical axis OA. Differently, the ninth surface S9 may have a concave shape on the optical axis OA, and the tenth surface S10 may have a concave shape on the optical axis OA. Differently, the ninth surface S9 may have a convex shape on the optical axis OA, and the tenth surface S10 may have a concave shape on the optical axis OA.

The fourth lens 104 has a convex shape on both sides, and the center thickness CT4 of the fourth lens 104 may be thicker than the edge thickness ET4, for example, may be at least twice the edge thickness. Accordingly, the distance between the fourth lens 104 and the fifth lens 105 may be reduced. The fourth lens 104 may be one of the lenses having the largest Abbe number among the lenses. The difference in the Abbe number between the fourth lens 104 and the fifth lens 105 may be greater than 20 or greater than 25, and may be at most 55 or less. Accordingly, the second lens group G2 may minimize the change in chromatic aberration caused by the position changing according to the change in the operation mode.

The sixth lens 106 may have positive (+) or negative (−) refractive power on the optical axis OA, and may have negative refractive power, for example. The sixth lens 106 may include a plastic or glass material, and may be, for example, a plastic material. The sixth lens 106 may include an eleventh surface S11 defined as an object-side surface and a twelfth surface S12 defined as a sensor-side surface. The eleventh surface S11 may have a concave shape on the optical axis OA, and the twelfth surface S12 may have a concave shape on the optical axis OA. That is, the sixth lens 106 may have a concave shape on both sides in the optical axis OA. Alternatively, the eleventh surface S11 may have a convex shape on the optical axis OA, and the twelfth surface S12 may have a convex shape on the optical axis OA. That is, the sixth lens 106 may have a convex shape on both sides in the optical axis OA. Alternatively, the eleventh surface S11 may have a concave shape on the optical axis OA, and the twelfth surface S12 may have a convex shape on the optical axis OA. Alternatively, the eleventh surface S11 may have a convex shape on the optical axis OA, and the twelfth surface S12 may have a concave shape on the optical axis OA. At least one of the eleventh surface S11 and the twelfth surface S12 of the sixth lens 106 may be an aspherical surface. For example, both the eleventh surface S11 and the twelfth surface S12 may be aspherical. The aspherical coefficients of the eleventh and twelfth surfaces S11 and S12 may be represented by L6S1 and L6S2 in FIG. 6. The eleventh surface S11 and the twelfth surface S12 may be provided without a critical point from the optical axis to the end of the effective area. The center thickness CT6 of the sixth lens 106 may be thinner than the edge thickness ET6. Accordingly, the incident light may be refracted in the direction of the optical axis by the difference between the center thickness CT6 and the edge thickness ET6 of the sixth lens 106.

The seventh lens 107 may have positive (+) or negative (−) refractive power on the optical axis OA, and may have positive refractive power. The refractive power of the seventh lens 107 has a sign opposite to that of the refractive power of the sixth lens 106, so that chromatic aberration can be improved. The seventh lens 107 may include a plastic or glass material, and may be, for example, a plastic material. The seventh lens 107 may include a thirteenth surface S13 defined as an object-side surface and a fourteenth surface S14 defined as a sensor-side surface.

The thirteenth surface S13 may have a convex shape on the optical axis OA, and the fourteenth surface S14 may have a convex shape on the optical axis OA. That is, the seventh lens 107 may have a convex shape on both sides in the optical axis OA. As another example, the thirteenth surface S13 may have a convex shape on the optical axis OA, and the fourteenth surface S14 may have a concave shape on the optical axis OA. Alternatively, the thirteenth surface S13 may have a concave shape on the optical axis OA, and the fourteenth surface S14 may have a convex shape on the optical axis OA. That is, the seventh lens 107 may have a convex meniscus shape toward the sensor in the optical axis OA. Alternatively, the thirteenth surface S13 may have a concave shape on the optical axis OA, and the fourteenth surface S14 may have a concave shape on the optical axis OA. That is, the seventh lens 107 may have a concave shape on both sides in the optical axis OA.

At least one of the thirteenth surface S13 and the fourteenth surface S12 of the seventh lens 107 may be an aspherical surface. For example, both the thirteenth surface S13 and the fourteenth surface S14 may be aspherical. The aspherical coefficients of the thirteenth and fourteenth surfaces S13, S14 may be represented by L7S1 and L7S2 of FIG. 6. The thirteenth surface S13 and the fourteenth surface S14 may be provided without a critical point from the optical axis to the end of the effective area. As another example, at least one of the thirteenth surface S13 and the fourteenth surface S14 of the seventh lens 107 may have a critical point between the optical axis and the end of the effective area, and the critical point is a point where the tendency of the Sag value changes. That is, the critical point is the point where the Sag value increases and then decreases on the lens surface, or the point where the Sag value decreases and then increases. The Sag value is the optical axis distance between the straight line perpendicular to the center of each lens surface and the lens surface, and the Sag value has a positive value at a position located closer to the sensor than the center of each lens surface, and a negative value at a position located closer to the object than the center of each lens surface.

The sixth lens 106 and the seventh lens 107 have refractive powers of opposite signs, and when the Abbe number difference is set to 10 or less, chromatic aberration can be controlled. Accordingly, the third lens group G3 can minimize the chromatic aberration change caused by the position changing according to the mode change and perform an achromatic role.

The eighth lens 108 can have a negative (−) refractive power at the optical axis OA. The eighth lens 108 can include a plastic or glass material, and can be, for example, a plastic material. The above eighth lens 108 may include a fifteenth surface S15 defined as an object-side surface and a sixteenth surface S16 defined as a sensor-side surface. The fifteenth surface S15 may have a convex shape on the optical axis OA, and the sixteenth surface S16 may have a concave shape on the optical axis OA. That is, the eighth lens 108 may have a meniscus shape convex from the optical axis OA toward the object side. Alternatively, the eighth lens 108 may have a concave shape on the optical axis OA, and the sixteenth surface S16 may have a convex shape on the optical axis OA. That is, the eighth lens 108 may have a meniscus shape convex from the optical axis OA toward the sensor side.

At least one of the fifteenth surface S15 and the sixteenth surface S16 of the eighth lens 108 may be aspherical. For example, both the fifteenth surface S15 and the sixteenth surface S16 may be aspherical. Aspherical coefficients of the fifteenth and sixteenth surfaces S15, S16 may be represented by L8S1 and L8S2 of FIG. 6. At least one of the fifteenth surface S15 and the sixteenth surface S16 may have a critical point from the optical axis to the end of the effective area. For example, the sixteenth surface S16 may have a critical point between the optical axis and the end of the effective area. As another example, both the fifteenth surface S15 and the sixteenth surface S16 may have critical points. The center thickness CT8 of the above-mentioned eighth lens 108 may be thinner than the edge thickness ET8. Accordingly, the difference between the center thickness and the edge thickness of the above-mentioned eighth lens 108 and the light incident by the critical point of the sixteenth surface S16 may be refracted to the periphery of the image sensor 300.

The above-mentioned third lens group G3 may be closest to the image sensor 300 among the plurality of lens groups G1, G2, and G3. The above-mentioned third lens group G3 may be moved in the direction of the optical axis, and the optical axis distance BFL between the above-mentioned eighth lens 108 and the image sensor 300 may vary depending on the operation mode. Here, the BFL is the optical axis distance from the center of the sensor-side surface of the above-mentioned eighth lens 108 to the image sensor 300. The third lens group G3 above can play a role in controlling the chief ray angle CRA. In detail, the CRA of the optical system 1000 according to the embodiment can be less than about 20 degrees, and the eighth lens 108 of the third lens group G3 can correct the chief ray angle of light incident on the image sensor 300 according to each operation mode.

The camera module according to the embodiment of the invention can include the optical system 1000 described above. The camera module can move two lens groups G2, G3 on the sensor side among the plurality of lens groups G1, G2, and G3 included in the optical system 1000 in the direction of the optical axis OA. The camera module can include a driving member (not shown) connected to the optical system 1000. The above driving members are arranged on the outer side of the second lens group G2 and the outer side of each of the third lens groups G3, and can move in the direction of the optical axis OA according to the operation mode. The operation mode may include a first mode in which the moving is performed at a first magnification as shown in FIG. 2, and a third mode in which the moving is performed at a second magnification different from the first magnification as shown in FIG. 3. At this time, the second magnification may be greater than the first magnification. In addition, the operation mode may include a second mode having a magnification between the first and third modes as shown in FIG. 1. Here, the first magnification may be the lowest magnification of the optical system 1000, and the second magnification may be the highest magnification of the optical system 1000. The first magnification may be about 1.5 times or more, for example, about 1.5 times to about 5 times, the second magnification may be about 6 times to about 11 times, and the third magnification may be about 4 times to about 6 times between the first and second magnifications. The first mode may be a wide mode, the second mode may be a middle mode, and the third mode may be a tele mode.

The driving member may move M1 and M2 each of the second and third lens groups G2, and G3 or operate them in an initial mode according to one operation mode selected from the first to third modes. In detail, each of the plurality of driving members is connected to the second lens group G2 and the third lens group G3, and may move the second lens group G2 or the third lens group G3 according to the operation mode. The initial mode may be one of the first, second, and third modes, for example, the second mode or the middle mode. For example, in the first mode, each of the second lens group G2 and the third lens group G3 may be positioned at a position defined as a first position (Position 1). In the second mode, each of the second lens group G2 and the third lens group G3 may be positioned at a position defined as a second position (Position 2) closer to the object than the first position. In the third mode, each of the second lens group G2 and the third lens group G3 may be positioned at a position defined as a third position (Position 3) closer to the sensor than the first position. The first position may be an area between the second and third positions.

The first position at which the second lens group G2 is positioned in the first mode may be an area between the second and third positions at which the second lens group G2 is positioned in the second and third modes. The first position at which the third lens group G3 is positioned in the first mode may be an area between the second and third positions at which the third lens group G3 is positioned in the second and third modes.

Depending on the operation mode, at least one of the second lens group G2 and the third lens group G3 may move M1 and M2 along the optical axis OA, and the first lens group G1 may be arranged at a fixed position. Depending on the operation mode, the second lens group G2 may move M1 along the optical axis OA, and the first lens group G1 may be arranged at a fixed position. Depending on the operation mode, the third lens group G3 can move M2 along the optical axis OA, and the first lens group G1 can be arranged at a fixed position. In each of the first position, the second position, and the third position according to the operation mode, the first to third lens groups G1, G2, and G3 can have a set interval from the adjacent lens groups. Accordingly, the optical system 1000 can have a constant TTL (Total track length) and a variable BFL depending on the operation mode, and the effective focal length and magnification of the optical system 1000 can be controlled by controlling the positions of some lens groups. In addition, the optical axis interval DG4 between the third lens group G3 and the optical filter 500 can be variable depending on the operation mode.

The effective length CA1 of the first lens 101 is the largest among the lenses, and the effective diameter CA6 of the sixth lens 106 is the smallest among the lenses. The effective length CA1 of the first lens 101 may be 5 mm or more. The effective length CA6 of the sixth lens 106 may be less than 5 mm, for example, 3.8 mm or more. In the absolute value of the focal length, the focal length F2 of the second lens 102 may be the largest among the lenses, and the difference (absolute value) of the focal length between adjacent two lenses may be the largest between the second and third lenses 102, 103, and the smallest between the sixth and seventh lenses 106, 107. The focal length of the fourth lens 104 may be the smallest among the lenses.

Among the lenses in the first lens group G1, the center thickness CT1 of the first lens 101 may be the thickest. The absolute value of the radius of curvature of the first to fourth surfaces S1, S2, S3, S4 of the first and second lenses 101, 102 may be set to 5 mm or more, so as not to significantly change the angle of refraction of the incident light, and may be guided to the fourth lens 104 of the second lens group G2 through the third lens 103. The sum of the center thicknesses CT3, CT4 of the third and fourth lenses 103, 104 of the second lens group G2 may be greater than the sum of the center thicknesses CT1, CT2, CT3 of the first, second, and third lenses 101, 102, and 103. The sum of the center thicknesses CT3, CT4 of the third and fourth lenses 103, 104 of the second lens group G2 may be greater than the sum of the center thicknesses CT6, CT7, CT8 of the sixth, seventh, and eighth lenses 106, 107, and 108. Accordingly, the second lens group G2 may guide the light incident through the first lens group G1 to the effective area of the third lens group G3.

The optical axis distance DG12 between the first and second lens groups G1 and G2 and the optical axis distance DG23 between the second and third lens groups G2 and G3 may be at least 0.2 mm or more and at most 8 mm or less depending on the change in magnification of the operating modes. In detail, the optical axis distance DG12 between the first and second lens groups G1 and G2 can be moved by 0.2 mm or more, for example, within a range of 0.2 mm to 8 mm, and the optical axis distance DG23 between the second and third lens groups G2 and G3 can be moved by 1 mm or more, for example, within a range of 1 mm to 4 mm. In addition, the center distance DG4 between the eighth lens 108 and the optical filter 500 can be moved by 1 mm or more, for example, within a range of 1 mm to 10 mm.

The relationship between DG12, DG23, and DG4 in the first, second, and third modes is as follows.

DG4<DG23<DG12 First mode:

DG23<DG12<DG4 Second mode:

DG12<DG23<DG4 Third mode:

Depending on the operation mode, the F number of the optical system 1000 provides a brightness of 2.0 or more, and the F number may be in the range of 2.2 to 3.8. The aperture stop may be located between the first lens group G1 and the second lens group G2.

The optical system 1000 according to the embodiment may satisfy at least one or two or more of the mathematical equations described below. Accordingly, the optical system 1000 according to the embodiment may effectively correct aberrations that change according to a change in the operation mode. In addition, the optical system 1000 according to the embodiment can effectively provide an autofocus AF function for a subject at various magnifications, and can have a slim and compact structure.

Hereinafter, the optical axis distance between two adjacent lenses can be defined as CG1 to CG7 from the distance between the first and second lenses to the distance between the seventh and eighth lenses. The effective lengths of the object-side surface and the sensor-side surface of the first lens 101 to the object-side surface and the sensor-side surface of the eighth lens 108 can be defined as CA11, CA12 to CA81, CA82. The units of the thickness, distance, and effective diameter values are mm. In addition, the effective length can be defined as the major axis effective length or the maximum diameter when the shape of the lens surface includes a circular or non-circular shape, and the lens has a partially circular shape.

nL_G2>1(nL is an integer greater than or equal to 2) [Equation 1]

In Equation 1, nL_G2 means the number of lenses included in the second lens group G2. Here, nL_G1>nL_G2, nL_G3>nL_G2 may have the relationship.

0.7<CA41/CA11<1.5 [Equation 2]

In Equation 2, CA41 is the effective length of the seventh surface S7 of the fourth lens 104, and CA11 is the effective length of the first surface S1 of the first lens 101 or the effective length in the major axis direction. When Equation 2 is satisfied, a high EPD (Entrance Pupil Diameter) compared to the optical system can be provided. Preferably, 0.7<CA41/CA11<1 can be satisfied.

1<CT1/CT3<4 [Equation 3]

If Equation 3 satisfies the center thickness of the first and third lenses 101 and 103, the aberration characteristic in the optical system 1000 can be improved. Preferably, 2<CT1/CT3<3.5 can be satisfied.

0<CT1/CT4<1 [Equation 4]

If Equation 4 satisfies the center thickness of the first and fourth lenses 101 and 104, the optical system 1000 can improve the aberration characteristic. Preferably, 0.3<CT1/CT4<0.85 can be satisfied. The center thickness CT4 of the fourth lens 104 is the thickest among the lenses and has a convex shape on both sides, so that the fourth lens 104 can improve the light incident efficiency of the light incident on the first lens group G1 and refract the light into the effective area of the sixth lens 106 having the smallest effective length.

1<ET3/CT3<4 [Equation 5]

In Equation 4, ET3 means the thickness (mm) in the direction of the optical axis OA at the edge, which is the end of the effective area of the third lens 103. When the optical system 1000 according to the embodiment satisfies the Equation 5, the optical system 1000 can improve the distortion characteristics of the light passing through the first lens group G1. Preferably, 2<ET3/CT3<2.5 can be satisfied.

Here, if the center thickness of the i-th lens is CTi and the edge thickness of the i-th lens is ETi, the ratio of CTi/ETi can be the largest when i is 4 and the smallest when i is 8. That is, the lens with the largest difference between the center thickness and the edge thickness can be arranged as the object-side lens of the second lens group G2, and the lens with the smallest difference can be arranged as the sensor-side lens of the third lens group G3.

FG1<0 [Equation 6]

In Equation 6, FG1 is the effective focal length EFL of the first lens group G1, and can have a value smaller than 0. FG1 is the composite focal length of the first to third lenses. If Equation 6 is satisfied, the optical aberration of the optical system, i.e., the optical aberration of the first lens group G1, can be improved. The effective focal length of the second lens group G2 is FG2, and the effective focal length of the third lens is FG3, and the following Equations can be satisfied.

FG2*2<|FG1| [Equation 6-1]:

FG2<|FG3|<FG2*3(* is multiplication) [Equation 6-2]:

FG3<FG1| [Equation 6-3]:

In this way, by adjusting the focal length of each lens group, the refracted angle of light passing through the lenses can be adjusted.

CRA<20 [Equation 7]

In Equation 7, CRA (Chief Ray Angle) is the chief ray incident angle, and in the optical system, the incident angle of the chief ray may be less than 20 degrees at the most, and may be 15 degrees or less, depending on the first, second, and third modes. The first mode may be a wide mode, the second mode may be a middle mode, and the third mode may be a tele mode. Here, in the case of the first mode (Wide), the chief ray incident angle may be greater than the chief ray incident angle in the case of the second mode in a field of 1.0. In the case of the third mode (Tele), the chief ray incident angle may be 11 degrees or less in a field of 1.0, and the chief ray incident angle of the second mode may be smaller than the chief ray incident angle of the first mode. When Equation 6 is satisfied, the peripheral light ratio can be secured.

(TTL/DG1)>3.5 [Equation 8]

In Equation 8, DG1 is the optical axis distance of the first lens group G1, for example, the optical axis distance from the center of the object-side surface of the first lens 101 to the center of the sensor-side surface of the third lens 103. For example, DG1 means the distance (mm) in the optical axis OA of the first surface S1 of the first lens 101 and the sixth surface S6 of the third lens 103. TTL (Total track length) means the distance (mm) in the optical axis OA from the object-side first surface S1 of the first lens 101 to the upper surface of the image sensor 300. When the optical system 1000 according to the embodiment satisfies the Equation 8, the optical system 1000 has a relatively small TTL and can secure a peripheral light ratio.

The Equation 8 may further include the following Equations.

(TTL/DG2)<(TTL/DG1) [Equation 8-1]

DG3<DG2 [Equation 8-2]

Here, DG2 is the optical axis distance of the second lens group G2, and is the distance from the center of the object-side surface of the fourth lens 104 to the center of the sensor-side surface of the fifth lens 105. DG3 is the optical axis distance of the third lens group G3, and is the distance from the center of the object-side surface of the sixth lens 106 to the center of the sensor-side surface of the eighth lens 108.

2<TTL/EPD3<7 [Equation 9]

In Equation 9, EPD3 means the size of the EPD of the optical system 1000 when operating in the third mode, i.e., Tele mode. When the optical system 1000 according to the embodiment satisfies the Equation 9, the optical system 1000 can secure a bright image when operating in the third mode, and may be a minimum condition for securing an F number of 4 or less in Tele mode.

Preferably, 3<TTL/EPD3<5 can be satisfied.

3<TTL/EPD1<7 [Equation 9-1]

2<TTL/EPD2<7 [Equation 9-2]

(TTL/EPD3)<(TTL/EPD2)<(TTL/EPD1) [Equation 9-3]

In Equations 9-1 to 9-3, EPD1 is the size of the EPD of the optical system in the first mode (Wide), and EPD2 is the size of the EPD of the optical system in the second mode (Middle). When the optical system satisfies the above conditions, it can secure a bright image according to each mode.

2<CT_Max/CT_Min<6 [Equation 10]

In Equation 10, CT_Max is the thickest thickness among the center thicknesses of the lenses, and CT_Min is the thinnest thickness among the center thicknesses of the lenses, and when Equation 10 is satisfied, the optical system aberration characteristics can be improved. Preferably, 3<CT_Max/CT_Min<5.5 can be satisfied.

1<CA_Max/CA_Min<3 [Equation 11]

In Equation 11, CA_Max is the largest effective length among each lens surface, and CA_Min is the smallest effective diameter among each lens surface, and when Equation 11 is satisfied, the optical performance of the optical system can be maintained, and a camera module for a slim or compact structure can be provided. Preferably, 1<CA_Max/CA_Min<1.5 can be satisfied.

0.1<ΣCG_Wide/TTL<0.6 [Equation 12]

In Equation 12, ΣCG is the sum of the center distances between adjacent lenses, and ΣCG_Wide is the sum of the center distances between adjacent lenses in the first mode. When the optical system satisfies the Equation 12, the center distance DG12 between the first and second lens groups and the center distance between the second and third lens groups can be set according to the wide mode. The center distance DG12 between the first and second lens groups can be the center distance CG3 between the third and fourth lenses 103 and 104, and varies depending on the operation mode. The center distance DG23 between the second and third lens groups is the center distance CG5 between the fifth and sixth lenses 105, 106, and varies depending on the operation mode. Preferably, 0.3<ΣCG_Wide/TTL<0.5 can be satisfied.

0.05<ΣCG_Mid/TTL<0.4 [Equation 12-1]

0<ΣCG_Tele/TTL<0.3 [Equation 12-2]

In Equations 12-1 and 12-2, ΣCG_Mid is the sum of the center distances between adjacent lenses in the second mode, and ΣCG_Tele is the sum of the center distances between adjacent lenses in the third mode. When the optical system satisfies the Equations 12-1 and 12-2, the center distance DG12 between the first and second lens groups and the center distance between the second and third lens groups can be set according to the middle mode and the tele mode. Preferably, the condition of ΣCG_Tele<ΣCG_Mid<ΣCG_Wide can be satisfied. When the optical system 1000 according to the embodiment satisfies at least one or two or more of Equations 1 to 12, the optical system 1000 can have a slim structure. In addition, the optical system 1000 can have improved assembly properties and a mechanically stable shape.

0.5<DG1/DG2<2 [Equation 13]

In Equation 13, DG1 is the optical axis distance of the first lens group G1, and DG2 is the optical axis distance of the second lens group G2. By setting the optical axis distances of the first and second lens groups G1 and G2 in the Equation 13, the TTL can be adjusted. Preferably, 0.5<DG1/DG2<1.2 can be satisfied.

0.5<DG2/DG3<2 [Equation 14]

In Equation 14, DG2 is the optical axis distance of the second lens group G2, and DG3 is the optical axis distance of the third lens group G3. Preferably, 0.9<DG2/DG3<1.3 can be satisfied. When the optical system 1000 according to the embodiment satisfies at least one of the Equation 13 and Equation 14, it has a relatively small TTL and can provide various magnifications according to at least three mode changes.

0<CG2/TTL<0.2 [Equation 15]

In Equation 15, CG2 is the optical axis distance between the second lens 102 and the third lens 103. When the optical system 1000 satisfies the Equation 15, the optical system 1000 has a relatively small TTL and can control stray light incident on the first lens group G1 to have improved optical characteristics. Preferably, 0<CG2/TTL<0.1 can be satisfied.

2<TTL/(DG2+DG3)<5 [Equation 16]

The Equation 16 sets the sum of the optical axis distances of the TTL and the second and third lens groups G2, G3, and when the optical system 1000 satisfies the Equation 16, the optical system 1000 has a relatively small TTL and can improve chromatic aberration characteristics. Preferably, 2.2<TTL/(DG2+DG3)<3 can be satisfied.

20<Vd4−Vd5<70 [Equation 17]

In Equation 17, Vd4 means the Abbe Number of the fourth lens 104, and Vd5 means the Abbe Number of the fifth lens 105. When the absolute value of the difference in Abbe numbers between the fourth and fifth lenses of the optical system 1000 according to the embodiment satisfies the Equation 17, the optical system 1000 can improve the chromatic aberration characteristics. Preferably, it satisfies Vd5<Vd4, and 40<Vd4.

15<|Vd8−Vd7|<60 [Equation 18]

In Equation 18, Vd8 means the Abbe number of the eighth lens, and Vd7 means the Abbe number of the 7th lens. If the absolute value of the difference in the Abbe numbers of the 7th and eighth lenses satisfies the Equation 18, the optical system 1000 can improve the chromatic aberration characteristics. Preferably, Vd7<Vd8 is satisfied, and 40<Vd8 can be satisfied.

1.6<Nd1 [Equation 19]

In Equation 19, Nd1 means the refractive index of the d-line of the first lens 101. If the optical system 1000 according to the embodiment satisfies the Equation 19, the incident light can be dispersed, and the effective area of the lens arranged after the first lens 101 can be secured. Preferably, 1.65<Nd1 can be satisfied.

1.6<Nd5 [Equation 19-1]

1.6<Nd7 [Equation 19-2]

The refractive indices of the fourth and eighth lenses 104 and 108 may be less than 1.6. Among the lenses, the number of lenses having a refractive index greater than 1.60 may be greater than the number of lenses having a refractive index less than 1.60.

1<L1R1/L3R2<3.5 [Equation 20]

In Equation 20, L1R1 means the radius of curvature of the object-side first surface S1 of the first lens 101, and L3R2 means the radius of curvature of the sensor-side sixth surface S6) of the third lens 103. When the optical system 1000 according to the embodiment satisfies the Equation 20, the optical system 1000 can control stray light incident on the first lens group G1. Preferably, 2<L1R1/L3R2<3 can be satisfied. Since the third lens 103 has a sensor-side surface having a concave shape on the optical axis, the effective diameter of the fourth lens 104 can be suppressed from increasing.

1.5<L1R1/L4R1<3.5 [Equation 21]

In Equation 21, L1R1 means the radius of curvature of the object-side first surface S1 of the first lens 101, and L4R1 means the radius of curvature of the object-side seventh surface S7 of the fourth lens 104. When the optical system 1000 according to the embodiment satisfies the Equation 21, the optical system 1000 can have good optical performance at various magnifications. Preferably, 2<L1R1/L4R1<3 can be satisfied.

0<L3R2/L4R1<2 [Equation 22]

In Equation 22, L3R2 means the radius of curvature of the sensor-side sixth surface S6 of the third lens 103, and L4R1 means the radius of curvature of the object-side seventh surface S7 of the fourth lens 104. When the optical system 1000 according to the embodiment satisfies the Equation 22, the optical system 1000 can have good optical performance in the periphery of the field of view (FOV) when operating at various magnifications of at least three modes. Preferably, 0.5<L3R2/L4R1<1.5 can be satisfied. The fourth lens 104 is the first lens of the second lens group G2, has a biconvex shape on the optical axis, and can have positive power. Accordingly, the distance between the convex sensor-side surface of the fourth lens 104 and the concave object-side surface of the fifth lens 105 can be tightly closed.

1<L1R1/L8R2<3 [Equation 23]

In Equation 23, L8R2 means the radius of curvature of the sensor-side sixteenth surface S16 of the eighth lens 108. When the optical system 1000 satisfies the Equation 23, the optical system 1000 can have good optical performance at the center and periphery of the field of view (FOV). Preferably, 2<L1R1/L8R2<3 can be satisfied.

Here, if the radius of curvature of the object-side surface of the i-th lens is R1i and the radius of curvature of the sensor-side surface is R2i, the absolute value of R1i/R2i may be the largest when i is 3 and the smallest when i is 1. For example, the absolute value of R13/R23 when i is 3 is 50 or more, and the absolute value of R11/R21 when i is 1 is 0.5 or less. In addition, lenses where the absolute value of R1i/R2i is less than 1 may be i=1, 2, 4, 5, 7.

0<Md12_mG2/TTL<0.5 [Equation 24]

In Equation 24, Md12_mG2 means the difference in center distance (unit: mm) after the movement of the second lens group G2 when changing from the second mode to the first mode or from the first mode to the second mode. In detail, the Md12_mG2 represents the movement distance of the second lens group G2 in the first and second modes, and means the difference value between the optical axis distance between the first and second lens groups G1, G2 in the first mode and the optical axis distance between the first and second lens groups G1, G2 in the second mode. When the optical system 1000 according to the embodiment satisfies the Equation 24, the optical system 1000 can minimize the movement distance of the second lens group G2 when the magnification is changed, so that the optical system 1000 can have a slim structure. In addition, since the movement distance can be minimized when controlling the position of the second lens group G2, it can have improved power consumption characteristics. Preferably, 0<Md12_mG2/TTL<0.2 can be satisfied.

0<Md23_mG2/TTL<0.5 [Equation 25]

In Equation 25, Md23_mG2 means the difference in the center distance (unit: mm) after the movement of the second lens group G2 when operating from the second mode to the third mode, or from the third mode to the second mode. In detail, Md23_mG2 means the difference value between the optical axis distance between the first and second lens groups G1, G2 in the second mode and the optical axis distance between the first and second lens groups G1, G2 in the third mode. The maximum movement distance of the second lens group G2 may be greater than the maximum movement distance of the third lens group G3. When the optical system 1000 according to the embodiment satisfies the Equation 25, the optical system 1000 can minimize the movement distance of the second lens group G2 when the magnification is changed, so that the optical system 1000 can have a slim structure. In addition, the movement distance can be minimized when controlling the position of the second lens group G2, so that it can have improved power consumption characteristics. It can satisfy 0<Md23_mG2/TTL<0.1. In addition, it can satisfy the condition of Md23_mG2<Md12_mG2.

0.3<Md12_mG2/DG2<1 [Equation 26]

The Equation 26 can set the movement distance of the second lens group G2 and the optical axis distance of the second lens group G2. When the optical system 1000 satisfies the Equation 26, the optical system 1000 can minimize the movement distance of the second lens group G2 when the magnification is changed, so that the optical system 1000 can have a slim structure. In addition, the movement distance can be minimized when the position of the second lens group G2 is controlled, so that it can have improved power consumption characteristics. Preferably, 0.3<Md12_mG2/DG2<0.8 can be satisfied.

0<Md23_mG3/DG3<0.5 [Equation 27]

In Equation 27, Md23_mG3 means the difference in the center distance after the movement of the third lens group G3 when changing from the second mode to the third mode, or from the third mode to the second mode. When the optical system 1000 satisfies the Equation 27, the optical system 1000 can minimize the movement distance of the third lens group G3 when the magnification is changed, so that the optical system 1000 can have a slim structure. In addition, the movement distance can be minimized when the position of the third lens group G3 is controlled, so that it can have improved power consumption characteristics. Preferably, 0.1<Md23_mG3/DG3<0.4 can be satisfied.

1<(CT1/ET1)/(CT3/ET3)<5 [Equation 28]

In Equation 28, CT1/ET1 is a value obtained by dividing the thickness of the optical axis of the first lens 101 by the thickness at the end, and CT3/ET3 is a value obtained by dividing the thickness of the optical axis of the third lens 103 by the thickness at the end. If the values obtained by dividing the center thickness and the end thickness of the first and third lenses 101, 103 satisfy the Equation 28 with the above ratio, chromatic aberration can be improved and incident light can be controlled. Preferably, 2<(CT1/ET1)/(CT3/ET3)<4 can be satisfied.

0<(CT1/ET1)/(CT7/ET7)<1 [Equation 29]

In Equation 29, CT1/ET1 is a value obtained by dividing the thickness of the seventh lens 107 at the optical axis by the thickness at the end. If the values obtained by dividing the center thickness and the end thickness of the first and seventh lenses 101, 107 satisfy the Equation 29 with the above ratio, chromatic aberration can be improved and incident light can be controlled. Preferably, 0.5<(CT1/ET1)/(CT7/ET7)<1 can be satisfied.

1<Md1(DG12/DG23)<5 [Equation 30]

In Equation 30, Md1 (DG12/DG23) represents a ratio between the center distance DG12 between the first and second lens groups in the first mode and the center distance DG23 between the second and third lens groups. When the optical system 1000 according to the embodiment satisfies the Equation 30, the optical system 1000 may have improved optical characteristics at the first magnification. In detail, the optical system 1000 may have improved aberration characteristics at the first magnification and may improve optical performance at the center and periphery of the field of view (FOV). Preferably, 1<Md1 (DG12/DG23)<3 may be satisfied.

0<Md3(DG12/DG23)<0.7 [Equation 31]

In Equation 31, Md3 (DG12/DG23) represents the ratio between the center distance DG12 between the first and second lens groups in the third mode and the center distance DG23 between the second and third lens groups. When the optical system 1000 according to the embodiment satisfies the Equation 31, the optical system 1000 may have improved optical characteristics at the second magnification. In detail, the optical system 1000 may have improved aberration characteristics at the second magnification and may improve optical performance at the periphery of the field of view (FOV). Preferably, 0<Md3 (DG12/DG23)<0.5 may be satisfied.

0.5<TD2/TTL<1 [Equation 32]

In Equation 32, TD2 is the optical axis distance from the center of the object-side surface of the first lens to the center of the sensor-side surface of the eighth lens in the second mode. When the optical system 1000 according to the embodiment satisfies the Equation 32, the optical system 1000 may have improved optical characteristics in the middle mode, which is the second mode. In detail, the optical system 1000 may have improved aberration characteristics in the middle mode and may improve the optical performance of the peripheral part of the field of view (FOV). Preferably, 0.65<TD2/TTL<0.9 may be satisfied.

1<TD1/TD2<1.5 [Equation 33]

In Equation 33, TD1 is the optical axis distance from the center of the object-side surface of the first lens to the center of the sensor-side surface of the eighth lens in the first mode. When the optical system 1000 according to the embodiment satisfies the Equation 33, the optical system 1000 can have improved optical characteristics in the first and second modes and can reduce the influence on TTL. In detail, the optical system 1000 can have improved aberration characteristics in the first and second modes and can improve the optical performance of the peripheral part of the field of view (FOV). Preferably, 1<TD1/TD2<1.4 can be satisfied.

0.5<TD1/TTL<2 [Equation 33-1]

Preferably, 0.5<TD1/TTL<1 can be satisfied. The relationship between the maximum optical axis distance TD1 and TTL according to each mode can be set.

1<TD1/TD3<1.5 [Equation 33-2]

In Equation 33-2, TD3 is the optical axis distance from the center of the object-side surface of the first lens to the center of the sensor-side surface of the eighth lens in the third mode. The optical system 1000 can have improved optical characteristics in the first and third modes, and can reduce the influence on TTL.

10 mm<TD3<TD2<TD1<22 mm [Equation 34]

The Equation 34 is a drawing comparing the optical axis distances of lenses in the first, second, and third modes, and TD3 is the optical axis distance from the center of the object-side surface of the first lens to the center of the sensor-side surface of the eighth lens in the third mode. When the optical system 1000 according to the embodiment satisfies the Equation 34, the optical system 1000 can have improved optical characteristics in the first, second, and third modes. In detail, the optical system 1000 can have improved aberration characteristics in the first, second, and third modes and improve optical performance in the peripheral portion of the field of view (FOV).

0.1<BFL2/TTL<1 [Equation 35]

In Equation 35, BFL2 (Back focal length1) is the optical axis distance from the center of the sensor-side surface of the eighth lens to the upper surface of the image sensor in the second mode. When the optical system 1000 according to the embodiment satisfies the Equation 35, the optical system 1000 can adjust the focus position to the upper surface of the image sensor 300 in the second mode. In detail, the optical system 1000 has improved optical characteristics in the second mode and can improve optical performance in the periphery of the field of view (FOV). Preferably, it can satisfy 0.2<BFL2/TTL<0.5.

2<BFL3/BFL1<4 [Equation 36]

In Equation 36, BFL3 is an optical axis distance from the center of the sensor-side surface of the eighth lens to the upper surface of the image sensor in the third mode. When the optical system 1000 according to the embodiment satisfies the Equation 36, the optical system 1000 can adjust the focus position to the upper surface of the image sensor 300 in the first and third modes. In detail, the optical system 1000 has improved optical characteristics in the first and third modes and can improve optical performance in the periphery of the field of view (FOV). Preferably, 2.5<BFL3/BFL1<3.1 can be satisfied.

1<TD3/BFL3<3 [Equation 37]

The Equation 37 is a value comparing the optical axis distance TD3 between the center of the object-side surface of the first lens and the center of the sensor-side surface of the eighth lens in the third mode, and the optical axis distance BFL3 from the center of the sensor-side surface of the eighth lens 108 to the upper surface of the image sensor. When the optical system 1000 according to the embodiment satisfies the Equation 37, the optical system 1000 can have improved optical characteristics in the third mode. In detail, the optical system 1000 can have improved aberration characteristics in the third mode and improve optical performance in the periphery of the field of view (FOV). Preferably, 1.3<TD3/BFL3<2.1 can be satisfied.

2<Md_CG_Max/Md_CG_Min<8 [Equation 38]

In Equation 38, Md_CG_Max means the maximum center distance among the center distances between the first to eighth lenses in the first, second, and third modes, and Md_CG_Min means the minimum center distance among the center distances between the first to eighth lenses in the first, second, and third modes. When the optical system satisfies the Equation 38, the optical axis distances of the TTL and lenses according to each mode can be adjusted. Preferably, 4<Md_CG_Max/Md_CG_Min<7 can be satisfied.

1 mm<BFL1<6 mm [Equation 39]

The Equation 39 represents the optical axis distance between the eighth lens and the image sensor in the first mode. When the optical system satisfies the Equation 39, the focus position toward the top surface of the image sensor in the first mode can be adjusted. Preferably, it can include 2 mm<BFL1<3.5 mm.

20<Aver_Vd<45 [Equation 40]

In Equation 40, Aver_Vd is the average of Abbe numbers of the first to eighth lenses. When the optical system satisfies the Equation 40, the optical system 1000 can have improved aberration characteristics and resolution. Preferably, it can satisfy 25<Aver_Vd<40.

1.5<Aver_Nd<1.8 [Equation 41]

In Equation 40, Aver_Nd is the average of refractive indices of the first to eighth lenses. When the optical system satisfies the Equation 41, the optical system 1000 can have improved aberration characteristics and resolution. Preferably, 1.58<Aver_Nd<1.68 can be satisfied.

10<ΣVd/ΣNd<40 [Equation 41-1]

In Equation 41-1, ΣVd means the sum of the Abbe numbers of each of the plurality of lenses. ΣNd means the sum of the refractive indices of each of the plurality of lenses. When the optical system 1000 according to the embodiment satisfies the Equation 41-1, the optical system 1000 can have improved aberration characteristics and resolution. Preferably, the Equation 41-1 can satisfy 17<ΣVd/ΣNd<25. Preferably, the condition of (ΣVd−ΣNd)<250 can be satisfied.

2<|FG1/FG2|<4 [Equation 42]

In Equation 42, FG1 represents the effective focal length EFL of the first lens group G1, and FG2 represents the effective focal length of the second lens group G2. FG2 is the composite focal length of the fourth and fifth lenses. If the Equation 42 is satisfied, the size of the optical system, for example, the total track length TTL, can be reduced. Preferably, FG2>0 is satisfied. FG3 is the composite focal length of the sixth to eighth lenses, and FG3<0, and the condition of |FG1|>|FG3|>FG2 can be satisfied. Preferably, 2<|FG1/FG2|<3.5 can be satisfied.

1<FMd2/FMd1<10 [Equation 43]

In Equation 43, FMd1 is the effective focal length of the optical system in the first mode, and FMd2 is the effective focal length of the optical system in the second mode. Preferably, 1<FMd2/FMd1<3 can be satisfied. When the optical system satisfies the Equation 43, the effective focal length can be adjusted according to the first and second modes.

1<FMd3/FMd2<10 [Equation 43-1]

In Equation 43, FMd3 is the effective focal length of the optical system in the third mode. Preferably, 1<FMd3/FMd2<2 can be satisfied, and the condition of (FMd3/FMd1)>(FMd3/FMd2) can be satisfied. If the optical system satisfies the Equation 43-1, the effective focal length can be adjusted according to the second and third modes.

In the first mode, the effective focal length Fmd1 of the optical system and the focal length of each lens can satisfy the following conditions.

2<|F1/Fmd1|<7 Condition 1:

1.5<F2/Fmd1<4 Condition 2:

0.6<|F3/Fmd1|<1.6 Condition 3:

0<F4/Fmd1<1 Condition 4:

2<|F5/Fmd1|<4 Condition 5:

0.5<|F6/Fmd1|<1.5 Condition 6:

0.5<F7/Fmd1<1.5 Condition 7:

0.6<|F8/Fmd1|<1.6 Condition 8:

The effective focal length Fmd2 of the optical system in the second mode and the focal length of each lens are the following conditions can be satisfied.

0<|F1/Fmd2|<1 Condition 1:

1<F2/Fmd2<4 Condition 2:

1<|F3/Fmd2|<2 Condition 3:

2<F4/Fmd2<4 Condition 4:

0<|F5/Fmd2|<1 Condition 5:

1<|F6/Fmd2|<3 Condition 6:

1<F7/Fmd2<3 Condition 7:

1<|F8/Fmd2|<3 Condition 8:

In the third mode, the effective focal length Fmd3 of the optical system and the focal length of each lens can satisfy the following conditions.

0<|F1/Fmd3|<1 Condition 1:

0.8<F2/Fmd3<2 Condition 2:

1<|F3/Fmd3|<2.5 Condition 3:

3<F4/Fmd3<6 Condition 4:

0<|F5/Fmd3|<1 Condition 5:

1<|F6/Fmd3|<3 Condition 6:

1<F7/Fmd3<3 Condition 7:

1<|F8/Fmd3|<2.8 Condition 8:

2<FMd2/EPD2<7 [Equation 44]

In Equation 44, FMd2 is the effective focal length of the optical system in the second mode (Middle), and EPD2 means the size of the entrance pupil (Entrance Pupil Diameter, EPD) of the optical system 1000 in the second mode. When the optical system 1000 according to the embodiment satisfies the Equation 44, the optical system 1000 can secure a bright image when operating in the second mode. Preferably, 2<FMd2/EPD2<4 can be satisfied.

0.1<FMd1/EPD1<3 [Equation 45]

In Equation 34, FMd1 is the effective focal length of the optical system in the first mode (Wide), and EPD1 means the size of the entrance pupil (Entrance Pupil Diameter, EPD) of the optical system 1000 when operating in the first mode. When the optical system 1000 according to the embodiment satisfies the Equation 45, the optical system 1000 can secure a bright image when the first mode is operated. Preferably, 1<FMd1/EPD1<3 can be satisfied.

FMd1<FMd2<FMd3 [Equation 46]

In Equation 46, FMd1, FMd2, and FMd3 represent effective focal lengths of the optical system in the first, second, and third modes. The effective focal length in the third mode may be the largest, and the effective focal length in the first mode may be the smallest.

0<TTL/FMd2<2 [Equation 47]

The Equation 47 can adjust the TTL by comparing the effective focal lengths in the TTL and second modes. Preferably, 1<TTL/FMd2<2 can be satisfied.

0.1<TTL/FMd1<5 [Equation 48]

The Equation 47 can adjust TTL by comparing the effective focal length in TTL and the first mode. Preferably, 1<TTL/FMd1<3 can be satisfied.

1<CA_Max/ImgH<3 [Equation 49]

In Equation 49, CA_Max means the largest effective length CA among the lens surfaces of the plurality of lenses included in the optical system 1000. ImgH is the distance from the 0 field area of the image sensor 300 centering on the image surface overlapping with the optical axis OA to the 1.0 field area of the image sensor 300. The ImgH means ½ of the maximum diagonal length of the effective area of the image sensor 300. When the optical system 1000 according to the embodiment satisfies the Equation 49, the optical system 1000 can be provided slim and compactly. In addition, the optical system 1000 can implement high resolution and high image quality. The range of the ImgH is 2 mm or more, for example, 2 mm to 3 mm. Here, the effective lengths CA1 to CA8 of the first to eighth lenses 101 to 108 can satisfy the following conditions.

0.5<CA1/(Imgh*2)<1.5 Condition 1:

Preferably, CA1>(Imgh*2) can be satisfied.

0.4<CA2/(Imgh*2)<1.4 Condition 2:

Preferably, CA2>(Imgh*2) can be satisfied.

And, CA3<(Imgh*2), CA5<(Imgh*2), CA6<(Imgh*2), CA7<(Imgh*2), CA8<(Imgh*2) can be satisfied. Also, CA4>(Imgh*2) can be satisfied.

When the effective length of the object-side surface of the first lens 101 is CA11 and the effective length of the sensor-side surface is CA12, the following condition can be satisfied.

1<CA11/(Imgh*2)<1.5 Condition 1:

0.8<CA12/(Imgh*2)<1.2 Condition 2:

5<TTL/ImgH<12 [Equation 50]

If the optical system 1000 satisfies the Equation 50, the optical system 1000 can have a smaller TTL, so that the optical system 1000 can be provided slim and compactly. Preferably, it can be in the range of 6<TTL/ImgH<10.

1<BFL2/ImgH<3 [Equation 51]

If the optical system 1000 according to the embodiment satisfies the Equation 51, the BFL required for a small image sensor less than 1 inch can be secured. In addition, when the optical system 1000 satisfies the Equation 51, the optical system 1000 can operate at various magnifications while maintaining TTL, and can have excellent optical characteristics at the center and periphery of the field of view (FOV). Preferably, it can be in the range of 2<BFL2/ImgH<3.

2<BFL3/ImgH<4 [Equation 52]

When the optical system 1000 according to the embodiment satisfies the Equation 52, the BFL required for a small image sensor less than 1 inch can be secured. When the optical system 1000 satisfies the Equation 52, the optical system 1000 can operate at various magnifications while maintaining TTL, and can have excellent optical characteristics at the center and periphery of the field of view (FOV). Preferably, 2.5<BFL3/ImgH<3.5 can be satisfied.

1<EPD1<EPD2<EPD3<7 [Equation 53]

In Equation 53, EPD1, EPD2, and EPD3 represent the size of the incident pupil of the optical system according to the first to third modes, and the brightness according to each mode can be adjusted.

0<Max_Distortion<3 [Equation 54]

In Equation 54, distortion means the maximum value or the maximum value of the distortion from the center (0.0 F) of the image sensor to the diagonal end (1.0 F) based on the optical characteristics detected by the image sensor 300. When the optical system 1000 satisfies the Equation 54, the optical system 1000 can improve the distortion characteristics and set the conditions for image processing. Preferably, Max_Distortion<1.5 can be satisfied.

8°<FOV3<FOV2<FOV1<45° [Equation 55]

In Equation 55, FOV1, FOV2, and FOV3 represent the diagonal angles of view of the optical system in the first, second, and third modes. FOV (Field of view) represents the diagonal angle of view (Degree) of the optical system 1000, and can provide an optical system of less than 45 degrees. In addition, the relationship between the angle of view FOV1, FOV2, FOV3 according to each mode and the optical axis distance BFL1, BFL2, BLF3 between the last lens and the image sensor 300 can satisfy the following conditions.

5<FOV1/BFL1<15 Condition 1:

2.5<FOV2/BFL2<5 Condition 2:

1<FOV3/BFL3<2.5 Condition 3:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 56 ]$$

In Equation 56, Z may mean a distance in the direction of the optical axis from an arbitrary position on the aspherical surface to the vertex of the aspherical surface with Sag. In addition, Y may mean a distance in the direction perpendicular to the optical axis from an arbitrary position on the aspherical surface to the optical axis. In addition, c may mean the curvature of the lens, and K may mean the conic constant. In addition, A, B, C, D, E, and F may mean aspheric constants.

The optical system 1000 according to the embodiment may satisfy at least one of the above-described Equations 1 to 55. Accordingly, the optical system 1000 and the camera module may have improved optical characteristics. In detail, since the optical system 1000 satisfies at least one or more of the Equations 1 to 55, it can effectively compensate for optical characteristic degradation such as chromatic aberration, vignetting, diffraction effect, and deterioration of image quality in the peripheral area caused by movement of the lens group. In addition, the optical system 1000 according to the embodiment can significantly reduce the movement distance of the lens group and provide an autofocus AF function for various magnifications with excellent power consumption characteristics.

Since the optical system 1000 according to the embodiment satisfies at least one or more of the Equations 1 to 55, it can have improved assembly properties and a mechanically stable form, and it can be provided with a slim structure, so that the optical system 1000 and the camera module including it can have a compact structure.

Hereinafter, the optical system 1000 according to the embodiment and the first to third mode changes will be described in more detail. In an optical system 1000 according to an embodiment, the first lens group G1 can be fixed, and the second lens group G2 and the third lens group G3 can move according to an operation mode. The first lens group G1 can include three lenses, for example, the first to third lenses 101, 102, and 103, and the second lens group G2 can include two lenses, for example, the fourth and fifth lenses 104 and 105. In addition, the third lens group G3 can include three lenses, for example, the sixth to eighth lenses 106, 107, and 108. In the optical system 1000 according to the embodiment, the object-side surface (the seventh surface S7) of the fourth lens 104 may function as an aperture, and the optical filter 500 described above may be arranged between the fourth lens group G4 and the image sensor 300.

FIG. 5 illustrates the radius of curvature (Radius of Curvature) of the optical axis OA of the first to eighth lenses 101-108, the center thickness CT of the lenses, adjacent components such as the center distance CG between the lenses, the refractive index (Refractive index) at the d-line, the Abbe number, and the effective length CA. In FIG. 5, DG4 is the optical axis distance between the eighth lens and the optical filter 500, and may vary depending on the movement of the third lens group G3.

TABLE 1

| Lens Groups | Lens | CT/ETs |
|---|---|---|
| First | First lens | 1.48 |
| lens group | Second lens | 0.91 |
| | Third lens | 0.45 |
| Second | Fourth lens | 2.52 |
| lens group | Fifth lens | 0.89 |
| Third | Sixth lens | 0.81 |
| lens group | Seventh lens | 2.07 |
| | Eighth lens | 0.48 |

Referring to Table 1, the ratios CT/ET of the center thickness CT and edge thickness ET of each lens may be different from each other, and the CT/ET value of the fourth lens 104 may be the largest, and the CT/ET value of the eighth lens may be the smallest. As shown in FIGS. 1 and 2, the Abbe number Vd4 of the fourth lens 104 included in the second lens group G2 may be 20 or more higher than the Abbe number Vd5 of the fifth lens 105. Since the fourth lens 104 and the fifth lens 105 have the above-described Abbe number difference, the chromatic aberration change that occurs when the magnification changes according to the movement M1 of the second lens group G2 can be minimized. As shown in FIG. 1 and FIG. 3, the Abbe number Vd8 of the eighth lens 108 included in the third lens group G3 can be 20 or more or 30 or more higher than the Abbe number Vd7 of the seventh lens 107. Since the seventh lens 107 and the eighth lens 108 have the above-described Abbe number difference, the chromatic aberration change that occurs when the magnification changes according to the movement M2 of the third lens group G3 can be minimized and/or compensated for, thereby performing an achromatic function.

The camera module according to the embodiment can obtain information about a subject at various magnifications. In detail, the driving member can control the positions of the second lens group G2 and the third lens group G3, and thereby the camera module can operate at various magnifications. For example, referring to FIGS. 1, 8, and 11, the camera module including the optical system 1000 can operate in the first mode having a first magnification. The first magnification can be about 3 to about 5 times. In detail, in an embodiment, the first magnification can be about 3.5 times. In the first mode, each of the second lens group G2 and the third lens group G3 can be moved to a set position. Accordingly, each of the first to third lens groups G3 can be arranged at a set interval. For example, the second lens group G2 may be positioned in an area spaced apart from the first lens group G1 by a first interval DG12, and the third lens group G3 may be positioned in an area spaced apart from the second lens group G2 by a second interval DG23. Here, the first and second intervals DG12, DG23 may mean intervals between the lens groups on the optical axis OA, and may vary depending on the operation mode.

When the camera module operates in the first mode, the optical system 1000 may have a TTL (Total track length) value and a BFL1 value at the first position. In addition, the optical system 1000 may have an FMD1 defined as a first effective focal length EFL at the first position. In addition, in the first mode, the field of view (FOV) of the camera module may be less than about 35 degrees, and the F-number may be less than about 3. When the camera module operates in the second mode, the optical system 1000 may have a TTL (Total track length) value and a BFL2 value at a second position. In addition, the optical system 1000 may have a FMD2 defined as a second effective focal length EFL at the second position. In addition, in the second mode, the field of view (FOV) of the camera module may be less than about 25 degrees, and the F-number may be less than about 3.4. When the camera module operates in the third mode, the optical system 1000 may have a TTL (Total track length) value and a BFL3 value at a third position. In addition, the optical system 1000 may have a FMD3 defined as a third effective focal length EFL at the third position. Additionally, in the third mode, the field of view (FOV) of the camera module may be less than about 20 degrees, and the F-number may be less than about 4.

As shown in FIG. 6, the relative illumination RI in each mode can change depending on the height of the image sensor, and it can be seen that the relative illumination at the periphery or edge (1.0 Field) at the height (Field Height) of the image sensor is 50% or more. The optical system 1000 can have excellent aberration characteristics as shown in FIGS. 8 and 11 in the first mode. In detail, FIG. 8 is a graph of diffraction MTF characteristics of the optical system 1000 operating in the first mode (first magnification), and FIG. 11 is a graph of aberration characteristics. The diffraction MTF characteristic graph is measured in units of approximately 0.252 mm from a spatial frequency range of 0.000 mm to 2.2520 mm. In the diffraction MTF graph, T represents the MTF change in spatial frequency per millimeter of the tangential image, and R represents the MTF change in spatial frequency per millimeter of the radial image. Here, the MTF (Modulation Transfer Function) depends on the spatial frequency of cycles per millimeter. In the aberration graph of FIG. 11, it is a graph measuring spherical aberration (Longitudinal Spherical Aberration), astigmatic field curves, and distortion from left to right. In FIG. 8, the X-axis can represent the focal length (mm) and distortion (%), and the Y-axis can mean the height of the image. In addition, the graph for spherical aberration is a graph for light in wavelength bands of about 435 nm, about 486 nm, about 546 nm, about 587 nm, and about 656 nm, and the graph for astigmatism and distortion aberration is a graph for light in wavelength band of 546 nm. In the aberration diagram of FIG. 11, it can be interpreted that the closer each curve is to the Y-axis, the better the aberration correction function is. Referring to FIG. 11, it can be seen that the optical system 1000 according to the embodiment has measurement values close to the Y-axis in almost all areas.

Table 2 and FIG. 3 are about the items of the Equations described above in the optical system 1000 of the embodiment, including the TTL (Total track length) (mm), BFL (Back focal length), effective focal length (F) (mm), ImgH (mm), effective length CA (mm), thickness (mm), TTL (mm), TD (mm), which is the optical axis distance from the first surface S1 to the fourteenth surface S14, the focal lengths F1, F2, F3, F4, F5, F6, F7, F8 (mm) of each of the first to seventh lenses, the sum of the refractive indices of each lens, the sum of the Abbe numbers of each lens, the sum of the center thicknesses of each lens (mm), the sum of the center distances between adjacent lenses, the effective diameter, the diagonal angle of view (FOV) (Degree), the edge thickness ET, the focal lengths of the first and second lens groups, the F number, etc.

TABLE 2

| Items | Embodiment | Items | Embodiment |
|---|---|---|---|
| F1 | −49.777 | ET1 | 1.016 |
| F2 | 25.729 | ET2 | 0.616 |
| F3 | −11.081 | ET3 | 1.111 |
| F4 | 4.862 | ET4 | 0.896 |
| F5 | −30.840 | ET5 | 2.255 |
| F6 | −9.221 | ET6 | 2.464 |
| F7 | 9.393 | ET7 | 0.632 |
| F8 | −10.778 | ET8 | 1.036 |
| FG1 | −15.441 | ΣCG_Wide | 9.199 |
| FG2 | 5.954 | ΣCG_Mid | 5.758 |
| FG3 | −13.436 | ΣCG_Tele | 4.099 |
| ΣIndex | 12.974 | ImgH | 2.520 |
| ΣAbbe | 252.866 | TTL | 22.616 |
| ΣCT | 10.631 | | |

Table 3 illustrates the center distance between the first and second lens groups according to the first to third modes, the center distance between the second and third lens groups, the center distance between the eighth lens and the optical filter DG4, the effective focal length EFL according to each mode, the entrance pupil size EPD according to each mode, the optical axis distance TD of the lens according to each mode, and the F number, angle of view, and BFL according to each mode.

TABLE 3

| | First | Second | Third |
|---|---|---|---|
| Items | mode | mode | mode |
| DG12 (mm) | 5.053 | 2.462 | 0.554 |
| DG23 (mm) | 2.365 | 1.515 | 1.764 |
| DG4 (mm) | 1.686 | 5.065 | 6.686 |
| EFL(FMd1/FMd2/FMd3)(mm) | 9.900 | 14.85 | 19.8 |
| EPD(EPD1/EPD2/EPD3) | 4.291 | 4.978 | 5.645 |
| TD(TD1/TD2/TD3)(mm) | 19.830 | 16.389 | 14.730 |
| F-number | 2.307 | 2.983 | 3.508 |
| FOV (degree) | 31.156 | 20.868 | 15.645 |
| BFL (BFL1/BFL2/BFL3)(mm) | 2.786 | 6.227 | 7.886 |

Table 4 and Table 5 are results for the Equations 1 to 55 described above in the optical system 1000 of the embodiment. Referring to Table 5, it can be seen that the optical system 1000 satisfies at least one, two or more, or three or more of the Equations 1 to 55. In detail, it can be seen that the optical system 1000 according to the embodiment satisfies all of the Equations 1 to 55. Accordingly, the optical system 1000 can have good optical performance and excellent optical characteristics at the center and periphery of the field of view (FOV).

TABLE 4

| | |
|---|---|
| Equations | Embodiment |

| | | |
|---|---|---|
| 1 | nL_G2 > 1 | Satisfaction |
| 2 | 0.7 < CA41/CA11 < 1.5 | 0.897 |
| 3 | 1 < CT1/CT3 < 4 | 2.971 |
| 4 | 0 < CT1/CT4 < 1 | 0.664 |
| 5 | 1 < ET3/CT3 < 4 | 2.200 |
| 6 | FG1 < 0 | −15.441 |
| 7 | CRA < 20 | Satisfaction |
| 8 | (TTL/DG1) > 3.5 | 6.088 |
| 9 | 2 < TTL/EPD3 < 7 | 4.006 |
| 10 | 2 < CT_Max/CT_Min < 6 | 4.520 |
| 11 | 1 < CA_Max/CA_Min < 3 | 1.314 |
| 12 | 0.1 < ΣCG_Wide/TTL < 0.6 | 0.407 |
| 13 | 0.5 < DG1/DG2 < 2 | 0.845 |
| 14 | 0.5 < DG2/DG3 < 2 | 1.104 |
| 15 | 0 < CG2/TTL < 0.2 | 0.040 |
| 16 | 2 < TTL/(DG2 + DG3) < 5 | 2.698 |
| 17 | 20 < \|Vd4 \| − Vd5 < 70 | 36.466 |
| 18 | 15 < \|Vd8 − Vd7\| < 60 | 36.466 |
| 19 | 1.6 < Nd1 | 1.680 |
| 20 | 1 < L1R1/L3R2 < 3.5 | 2.536 |
| 21 | 1.5 < L1R1/L4R1 < 3.5 | 2.398 |
| 22 | 0 < L3R2/L4R1 < 2 | 0.946 |
| 23 | 1 < L1R1/L8R2 < 3 | 2.233 |
| 24 | 0 < Md12_mG2/TTL < 0.5 | 0.115 |
| 25 | 0 < Md23_mG2/TTL < 0.5 | 0.038 |
| 26 | 0.3 < Mde12_mG2/DG2 < 1 | 0.589 |
| 27 | 0 < Md23_mG3/DG3 < 0.5 | 0.213 |
| 28 | 1 < (CT1/ET1)/(CT3/ET3) < 5 | 3.250 |
| 29 | 0 < (CT1/ET1)/(CT7/ET7) < 1 | 0.715 |
| 30 | 1 < Md1 (DG12/DG23) < 5 | 2.137 |

TABLE 5

| | |
|---|---|
| Equations | Embodiment |

| | | |
|---|---|---|
| 31 | 0 < Md3 (DG12/DG23) < 0.7 | 0.314 |
| 32 | 0.5 < TD2/TTL < 1 | 0.725 |
| 33 | 1 < TD1/TD2 < 1.5 | 1.210 |
| 34 | 10 < TD3 < TD2 < TD1 < 22 | Satisfaction |
| 35 | 0.1 < BFL2/TTL < 1 | 0.275 |
| 36 | 2 < BFL3/BFL1 < 4 | 2.830 |
| 37 | 1 < TD3/BFL3 < 3 | 1.868 |
| 38 | 2 < Md_CG_Max/Md_CG_Min < 8 | 5.569 |
| 39 | 1 < BFL1 < 6 | 2.786 |
| 40 | 20 < Aver_Vd < 45 | 31.608 |
| 41 | 1.5 < Aver_Nd < 1.8 | 1.622 |
| 42 | 2 < \| FG1/FG2 \| < 4 | 2.593 |
| 43 | 1 < FMd2/FMd1 < 10 | 1.500 |
| 44 | 2 < FMd2/EPD2 < 7 | 2.983 |
| 45 | 0.1 < FMd1/EPD1 < 3 | 2.307 |
| 46 | FMd1 < FMd2 < FMd3 | Satisfaction |
| 47 | 0 < TTL/FMd2 < 2 | 1.523 |
| 48 | 0.1 < TTL/FMd1 < 5 | 2.284 |
| 49 | 1 < CA_Max/ImgH < 3 | 2.302 |
| 50 | 5 < TTL/ImgH < 12 | 8.975 |
| 51 | 1 < BFL2/ImgH < 3 | 2.471 |
| 52 | 2 < BFL3/ImgH < 4 | 3.129 |
| 53 | 1 < EPD1 < EPD2 < EPD3 < 7 | Satisfaction |
| 54 | 0 < Max_Distortion < 3 | 1.200 |
| 55 | 8 < FOV3 < FOV2 < FOV1 < 45 | Satisfaction |

The optical system and camera module according to the embodiment may satisfy at least one or two or more of Equations 1 to 30 and/or Equations 31 to 55, or may satisfy all Equations.

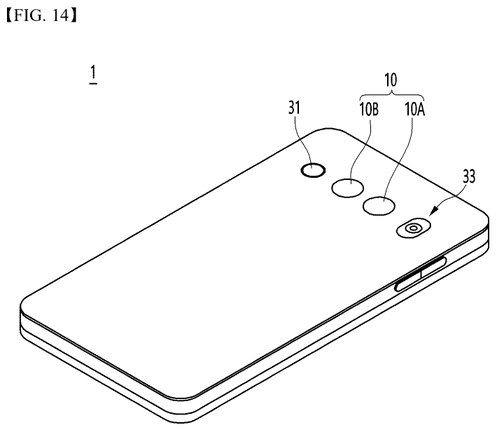

FIG. 14 is a drawing illustrating a camera module according to an embodiment applied to a mobile terminal. Referring to FIG. 14, the mobile terminal 1 may include the camera module 10 disclosed in the embodiment on the rear side. As another example, the mobile terminal 1 may include the camera module disclosed in the embodiment on the front side. The camera module 10 may include an image capturing function. In addition, the camera module 10 may include at least one of an auto focus, a zoom function, and an OIS function.

The camera module 10 can process a still image or a video image frame obtained by the image sensor 300 in the shooting mode or the video call mode. The processed image frame can be displayed on the display unit (not shown) of the mobile terminal 1 and can be stored in the memory (not shown). In addition, although not shown in the drawing, the camera module can be further arranged on the front of the mobile terminal 1. For example, the camera module 10 can include a first camera module 10A and a second camera module 10B. At this time, at least one of the first camera module 10A and the second camera module 10B can include the optical system 1000 described above. Accordingly, the camera module 10 can have a slim structure and can capture a subject at various magnifications.

The mobile terminal 1 can further include an autofocus device 31. The auto-focus device 31 may include an auto-focus function using a laser. The auto-focus device 31 may be mainly used in conditions where the auto-focus function using the image of the camera module 10 deteriorates, for example, in a close range of 10 m or less or in a dark environment. The auto-focus device 31 may include a light-emitting unit including a vertical cavity surface-emitting laser VCSEL semiconductor element, and a light-receiving unit such as a photodiode that converts light energy into electric energy. The mobile terminal 1 may further include a flash module 33. The flash module 33 may include a light-emitting element that emits light therein. The flash module 33 may emit light in a visible light wavelength band. For example, the flash module 33 may emit white light or light of a color similar to white. However, the embodiment is not limited thereto, and the flash module 33 may emit light of various colors. The above flash module 33 can be operated by the camera operation of the mobile terminal or the control of the user.

The features, structures, effects, etc. described in the embodiments above are included in at least one embodiment of the present invention, and are not necessarily limited to one embodiment. Furthermore, the features, structures, effects, etc. exemplified in each embodiment can be combined or modified and implemented in other embodiments by a person having ordinary knowledge in the field to which the embodiments belong. Therefore, the contents related to such combinations and modifications should be interpreted as being included in the scope of the present invention. Although the embodiments have been described above, they are merely examples and do not limit the present invention, and a person having ordinary knowledge in the field to which the present invention belongs will understand that various modifications and applications not exemplified above are possible without departing from the essential characteristics of the present embodiment. For example, each component specifically shown in the embodiments can be modified and implemented. And the differences related to such modifications and applications should be interpreted as being included in the scope of the present invention defined in the appended claims.

1.-20. (canceled)

21. An optical system comprising:
a first to third lens groups, each including at least one lens and arranged along an optical axis from an object side toward a sensor side,
wherein the first and third lens groups have negative power,
wherein the second lens group has positive power,
wherein a position of the first lens group is fixed,
wherein each of the second and third lens groups is movable along the optical axis in accordance with an operation mode,
wherein a first lens in the first lens group, which is closest to the object, has positive power and a convex surface on a sensor side,
wherein the third lens group includes a lens closest to the image sensor;
wherein a number of lenses in the second lens group is equal to or smaller than a number of lenses in the third lens group,
wherein a distance along the optical axis of the first lens group is defined as DG1,
wherein a distance along the optical axis of the second lens group is defined as DG2, and
wherein the following Equation satisfies:
0.5<DG1/DG2<2.

22. The optical system of claim 21, wherein lenses in the first to third lens groups are made of plastic, and the number of lenses having negative power is greater than the number of lenses having positive power in the first to third lens groups.

23. The optical system of claim 21, wherein the distance along the optical axis of the second lens group is greater than distances along the optical axis of each of the first and third lens groups.

24. The optical system of claim 21, wherein a lens having the largest absolute focal length among lenses in the first to third lens groups is disposed in the first lens group.

25. The optical system of claim 21, wherein a distance along the optical axis of the third lens group is defined as DG3, a distance along the optical axis from an object-side surface of the lens in the first lens group closest to the object to a top surface of the image sensor is defined as TTL, and the following Equation satisfies:
2<TTL/(DG2+DG3)<5.

26. The optical system of claim 21, wherein a distance along the optical axis between a lens closest to the image sensor in the third lens group and the image sensor is variable in accordance with the operation mode, and the operation mode includes a wide mode, a middle mode, and a tele mode, and
wherein the lens closest to the image sensor includes a convex object-side surface and a concave sensor-side surface on the optical axis.

27. The optical system of claim 26, wherein a distance along the optical axis between an object-side surface of the lens closest to the object in the first lens group and a sensor-side surface of the lens closest to the image sensor in the third lens group is variable in accordance with the operation mode, and a distance between the first and second lens groups and a distance between the second and third lens groups are equal to or greater than 0.2 mm and equal to or less than 8 mm.

28. The optical system of claim 26, wherein the wide mode is defined as Md1, a distance between the first and second lens groups in the wide mode is defined as DG12, a distance between the second and third lens groups is defined as DG23, and the following Equation satisfies:
1<Md1×(DG12/DG23)<3.

29. The optical system of claim 26, wherein the tele mode is defined as Md3, a distance between the first and second lens groups in the tele mode is defined as DG12, a distance between the second and third lens groups is defined as DG23, and the following Equation satisfies:
0<Md3×(DG12/DG23)<0.5.

30. The optical system of claim 21, wherein a maximum distance between adjacent lenses in accordance with the operation mode is defined as Md_CG_Max, a minimum distance between adjacent lenses in accordance with the operation mode is defined as Md_CG_Min, and the following Equation satisfies:
4<Md_CG_Max/Md_CG_Min<7.

31. The optical system of claim 21, wherein the number of lenses in the first lens group is greater than the number of lenses in the second lens group, and an absolute value of the focal length of the first lens group is more than twice that of the second lens group.

32. The optical system of claim 26, wherein an effective focal length in the wide mode is defined as FMd1, a focal length of the first lens is defined as F1, and the following Equation satisfies:
2<|F1/FMd1|<7.

33. The optical system of claim 26, wherein an effective focal length in the tele mode is defined as FMd3, and the following Equation satisfies:
0<|F1/FMd3|<1.

34. The optical system of claim 26, wherein a field of view in the wide mode is defined as FOV1, a field of view in the middle mode is defined as FOV2, a field of view in the tele mode is defined as FOV3, and the following Equation satisfies:
8°<FOV3<FOV2<FOV1<45°.

35. An optical system comprising:
a first lens group including first to third lenses;
a second lens group including fourth and fifth lenses; and
a third lens group including sixth to eighth lenses,
wherein the first to third lens groups are arranged in order from an object side toward a sensor side along an optical axis,
wherein the first lens has positive refractive power, and has convex surfaces on both object side and sensor side,
wherein the third lens has negative refractive power, and has a concave object-side surface and a convex sensor-side surface,
wherein the fourth lens has positive refractive power and a biconvex shape,
wherein the eighth lens has negative refractive power,
wherein the second and third lens groups are movable along the optical axis,
wherein a distance between the eighth lens and an image sensor is variable in accordance with an operation mode,
wherein the number of lenses having a refractive index greater than 1.60 among the first to eighth lenses is greater than the number of lenses having a refractive index less than 1.60,
wherein a refractive index of the first lens is defined as Nd1, and
wherein the following Equation satisfies:
1.65<Nd1.

36. The optical system of claim 35, wherein the first and third lens groups have negative refractive power, and the second and fourth lenses have refractive powers of opposite signs.

37. The optical system of claim 35, wherein the fourth lens and the eighth lens each have a refractive index less than 1.6.

38. The optical system of claim 35, wherein a surface of the third lens on the object side has the largest absolute radius of curvature among the object-side and sensor-side surfaces of the first to eighth lenses.

39. The optical system of claim 35, wherein an effective diameter of the first lens is the largest among the first to eighth lenses, a maximum length of the first lens in a first direction perpendicular to the optical axis is different from that in a second direction, a maximum effective size of the largest lens surface among the first to eighth lenses is defined as CA_Max, and half of a diagonal length of the image sensor is defined as ImgH, and
wherein the following Equation satisfies:
1<CA_Max/ImgH<3.

40. A camera module comprising:
an image sensor,
an optical system; and
a driving member configured to move at least one of a plurality of lens groups in the optical system along an optical axis,
wherein the optical system includes the optical system of claim 21, and the driving member is configured to move positions of each of the second and third lens groups in the optical axis.
